(19) United States
(12) Patent Application Publication
(10) Pub. No.: US 2018/0025460 A1
(43) Pub. Date: Jan. 25, 2018

(54) Warehouse Management System, Warehouse, and Warehouse Management Method

(71) Applicant: Hitachi Transport System, Ltd., Koto-ku, Tokyo (JP)

(72) Inventors: Takashi WATANABE, Tokyo (JP); Masaaki TANIZAKI, Tokyo (JP)

(21) Appl. No.: 15/550,442

(22) PCT Filed: Feb. 20, 2015
(86) PCT No.: PCT/JP2015/054801

§ 371 Date: Aug. 11, 2017

(51) Int. Cl. G06Q 50/28; G06Q 10/04; G06Q 10/06; B65G 1/137; G06Q 10/08

(52) U.S. Cl. CPC G06Q 50/28; B65G 1/137; G06Q 10/083; G06Q 10/087; G06Q 10/063112; G06Q 10/063114; G06Q 10/047

(57) ABSTRACT

Provided is a warehouse management system, comprising a processor and a storage device connected to the processor. The storage device retains work order information which indicates destinations of articles which are received into the warehouse and quantities of the articles to be shipped to each of the destinations, article attribute information including the weights of the articles, and layout information of the warehouse. On the basis of the work order information, the article attribute information, and the layout information, the processor calculates the energy consumption of a worker for carrying out, using each of a plurality of sorting methods, a operation of sorting the articles received into the warehouse for each of the destinations, and outputs the sorting method with the low calculated energy consumption.

### BACKGROUND OF THE INVENTION

This invention relates to a management system for a logistics warehouse for aggregating and distributing articles.

For product delivery from a factory to a client, it is desirable that the product be delivered in the shortest time as possible after rise of demand in the client. However, physically manufacturing a product usually takes a certain time, which is called lead time for manufacture (hereinafter, manufacturing lead time). In the case of make-to-order systems, the longer the manufacturing lead time, the more risk to diminish the satisfaction of the client or to change the client's mind to a different product. To reduce these risks, make-to-stock production based on the results of advance market research is common these days. The stock generated by the make-to-stock production is preferable to be stored in a place physically closer to the expected client, rather than the manufacturing site. This is because that lead time for delivery (hereinafter, delivery lead time) is the next issue when the manufacturing lead time is zero. A warehouse is used as a temporal storage space for this purpose. The logistics network from manufacture to delivery is called a supply chain; taking measures to reduce the manufacturing lead time and the delivery lead time is called supply chain management. In supply chain management, where to set up a manufacturing site and a warehouse site and how soon to dispatch the product from each site are important to strengthen the competitiveness of the company; companies are vigorously working on these issues.

The manufacturing lead time and the delivery lead time are determined by the time of transport between sites. The time of transport between sites is determined by the time from the issuance of a transport request until the start of the transport and the time taken by the transport from Site A to Site B. The latter may be varied depending on the selected mode of transport such as truck, aircraft:, vessel, and the like, the length of the route, and the obstruction such as traffic jam. The mode of transport and the route with less obstruction should be selected for delivery by a specified arrival time. The former is the time from receipt of an instruction about shipment until the shipment gets ready, inclusive of picking and packing the products. The quicker the picking and packing, the shorter this time. Particularly, in the craze of online shopping these days, the convenience to purchase (select) goods in small quantities from a various kinds of goods is an appeal point for clients. As a result, a challenge arises: to pick articles from a large amount of stock and forward the articles to packing as quick as possible after receipt of purchase information from a client.

To increase the picking speed (hereinafter, also called picking productivity), devices and robots for automating warehouse work have been introduced. Such a warehouse is called an automated warehouse. Some automated warehouses are capable of processing a huge amount of articles that cannot be handled by human in a short time; it is effective to process a large amount of articles in a short time. However, reasonable equipment would be required to construct an automated warehouse; the initial investment might become a risk if the prospect about the amount of articles is unclear. How far to automate the warehouse can be designed based on the prospect about the amount of articles; it is possible to partially operate the warehouse manually. For example, some warehouse can be designed to replenish storage racks with articles automatically and have articles picked from the storage racks manually. This is because replenishment can be made by handling a specific size of cartons or containers but picking needs handling individual articles having different shapes piece by piece; accordingly, it can be considered that manual work is suitable for picking.

For manual picking, various methods have been proposed to increase the efficiency. For example, JP 2011-225360 A discloses a picking rack device with a slanted shelf that allows the articles supplied from a supply port to move to a retrieval port by their own weights. This structure allows a next case such as a carton or a container to come down to the retrieval port only by removing an empty case from the retrieval port when all articles packed therein have been retrieved. Accordingly, the picking rack can store a certain number of articles in advance, preventing stockout in the picking rack and suspension of picking work because of replenishment. JP 2004-307110 A discloses a method to improve the efficiency in loading an article to a picking cart by allowing the picked article to lean against the back of the cart when loading the article. JP 2003-182808 A discloses a method to effectively perform picking and shelving by providing a turning area for a forklift in a specific area of a warehouse layout.

### SUMMARY OF THE INVENTION

To increase the picking speed (productivity) in picking articles (for example, commercial products), there are at least two approaches: improving the way of replenishment and improving the work method. This invention aims to increase the productivity by improving the work method.

To solve the foregoing problem, there is provided a warehouse management system comprising: a processor; and a storage device coupled to the processor, wherein the storage device holds work order information including shipping destinations of articles received at a warehouse and quantities of articles to be shipped to each of the shipping destinations, article attribute information including weights of articles, and layout information on the warehouse, and wherein the processor is configured to: calculate energy to be used by a worker to be involved in sorting work in sorting articles received at the warehouse by shipping destination in cases of using a plurality of methods of sorting, based on the work order information, the article attribute information, and the layout information; and output a method of sorting that is calculated to use the least energy.

An aspect of this invention increases work productivity at an article aggregating and distributing site represented by a logistics warehouse. The issues, configurations, and effects other than those described in the above are clarified by the following description of embodiments.

### BRIEF DESCRIPTION OF THE DRAWINGS

FIG. 1 is a block diagram for illustrating a hardware configuration of an overall warehouse system in an embodiment of this invention.

FIG. 2 is a functional block diagram of the warehouse system in the embodiment of this invention.

FIG. 3 is a sequence diagram for illustrating operation flow of the warehouse system in the embodiment of this invention.

FIG. 4 is a flowchart of processing to be performed by a warehouse management system in the embodiment of this invention in receiving work.

FIG. 5 is a flowchart of processing to be performed by the warehouse management system in the embodiment in starting sorting work.

FIG. 6 is a flowchart of processing to be performed by a receiving system in the embodiment: of this invention.

FIG. 7 is a flowchart of processing to be performed by a sorting system in the embodiment of this invention.

FIG. 8 is a flowchart of processing to be performed by the warehouse management system the embodiment of this invention to create master data.

FIG. 9A is a explanatory diagram of a work environment information in a master data held by the warehouse management system in the embodiment of this invention.

FIG. 9B is a explanatory diagram of a worker attribute information in the master data held by the warehouse management system in the embodiment of this invention.

FIG. 9C is a explanatory diagram of an article attribute information in the master data held by the warehouse management system in the embodiment of this invention.

FIG. 10A is an explanatory diagram of working status management data managed by the warehouse management system in the embodiment of this invention.

FIG. 10B is an explanatory diagram of cart information managed by the warehouse management system in the embodiment of this invention.

FIG. 10C is an explanatory diagram of temporary storage area information managed by the warehouse management system in the embodiment of this invention.

FIG. 11 is a flowchart of processing to be performed by the warehouse management: system in the embodiment: of this invention to calculate calories.

FIG. 12 is an explanatory diagram of calorie calculation to be performed by the warehouse management system in the embodiment of this invention.

FIG. 13 is an explanatory diagram of an example of a screen displayed by the receiving system in the embodiment of this invention.

FIG. 14 is an explanatory diagram of an example of a screen displayed by the sorting system in the embodiment of this invention during a work of placing articles.

FIG. 15 is an explanatory diagram of an example of a screen displayed on a tablet terminal to be used by a worker in sorting work in the embodiment of this invention.

FIG. 16 is an explanatory diagram for illustrating a configuration of a transfer center type warehouse in Example 1 of this invention.

FIG. 17 is an explanatory diagram for illustrating the work performed in a transfer center type warehouse in Example 1 in more detail.

FIG. 18 is an explanatory diagram of a first configuration example of a storage type warehouse in Example 2 of this invention.

FIG. 19 is an explanatory diagram of a second configuration example of a storage type warehouse in Example 2 of this invention.

FIG. 20 is an explanatory diagram for illustrating the work performed in a storage type warehouse in Example 2 in more detail.

FIG. 21 provides explanatory diagrams of methods of sorting.

FIG. 22 is an explanatory diagram of a configuration example of a temporary storage area in the embodiment of this invention.

### DETAILED DESCRIPTION OF THE EMBODIMENTS

Whether the operation of a logistics warehouse succeeds or fails depends on the productivity of the workers (or robots) as processing capability with respect to the amount of articles (the amount of work orders) to be processed as input. It is ideal to prepare workers (robots) without excess or shortage based on a correct estimation of the productivity after the amount of articles to be processed is fixed. However, the amount of articles to be processed is usually uncertain because of various disturbance factors; the correct estimation of productivity is not easy, either.

Furthermore, a logistics warehouse is required to complete the work by a predetermined shipping time; the failure of the work makes a significant negative impact onto the business continuity. As a result, the manager is obliged to design a safer plan by estimating the amount of articles larger and estimating the productivity lower, or to prepare extra workers. However, it is difficult to suggest an estimate with a big margin in order to prevail in the competitive environment; the productivity might be estimated higher than the capacity. This mismatch makes the business environment severer.

The productivity can be misestimated for the following reasons. In general, the productivity of a worker falls with remaining energy. However, the manager estimates the productivity as an average value in a certain period or of a certain number of workers. An optimistic manager considers that high productivity can be maintained all day long and tries to operate with a small number of workers; as a result, the work cannot be completed within the scheduled time. A pessimistic manager expects low productivity; as a result, too many workers are kept at too much cost.

This invention calculates the energy successively used by work and determines the initial layout of the articles (or the commercial products to be received in and shipped from the warehouse) and assignment of the work, considering the energy remaining in and available from each worker. The energy calculation uses the attributes of the workers (for example, physical attributes such as weight and height), the attributes of the articles (for example, the size and the weight), and the work environment information (for example, the basic layout and the temperature). This approach enables correct estimation of the amount of energy required for work, achieving operation of work in adequate conditions.

Conventional work assignment is based on the expectation that previous productivity equally represents future productivity; the future productivity tends to be overestimated (that is to say, the possibility that the work will not be completed in time is high). However, the system of this invention carries on the work with estimation of realistic productivity; therefore, the overestimation is eliminated. Particularly, this invention arrays the received total-picked articles two-dimensionally in accordance with the weight and the process distance, which are examples of major elements to determine the energy to he used, to adaptively switch the subsequent processing depending on the remaining energy. The process distance here means the travel distance of an article (the walking distance of a worker in the cases where the worker carries the article and the worker carries a cart containing the article) to do the subsequent work. In this description, the process distances in the cases of allocating method of sorting and order picking method of sorting are considered.

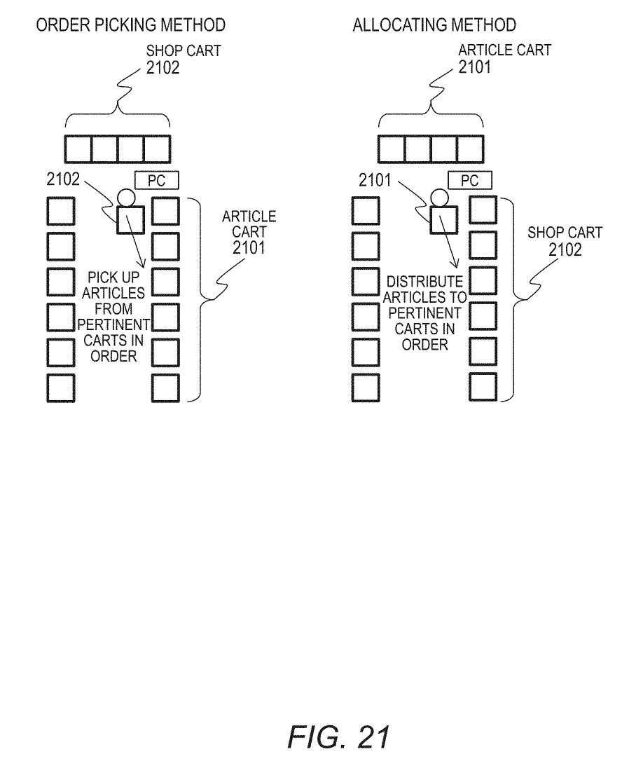

FIG. 21 provides explanatory diagrams of methods of sorting.

Allocating method is a method such that the worker first disposes a plurality of empty shop carts 2102 (or carts corresponding to shipping destinations) in the sorting work area and then, moves a plurality of article carts 2101 containing received articles one after another to distribute the articles in each article cart 2101 to the pertinent shop carts 2102. In contrast, order picking method is a method such that the worker first disposes a plurality of article carts 2101 in the sorting work area, and then moves a plurality of shop carts 2102, which are empty at the initial stage, one after another to pick up necessary articles from the article carts 2101 to each shop cart 2102.

The primary work in a logistics warehouse is picking articles in accordance with successively incoming shipping work orders from the articles having been distributed to predetermined compartments of racks, and packing and shipping the articles. Accordingly, the worker (or picker) leaves a packing area, picks up articles from the compartments of the racks in a picking area with reference to a shipping work order list, and returns to the packing area with articles after completion of picking all necessary articles, and repeats this work (this instance corresponds to a method called order picking). Completing the picking work at lowest cost and in shortest time as possible or increasing the productivity of each worker is an issue.

Conventionally, reduction of the overall walking distance of the pickers, which leads to increase in productivity of picking work, has been attempted through analyzing the trend of shipping work orders by classifying the shipping work orders based on the frequency of shipping (this classification is called ABC analysis) and allocating a compartment closer to the packing area for an article shipped more frequently. Placing a frequently-shipped article near the packing area and placing a rarely-shipped article far from the packing area balance the walking distance with the number of storage compartments. This is an idea for a distribution center (DC) type (or storage type) warehouse where the warehouse holds a certain amount of stock and the articles to he shipped are picked up from the stock.

In recent years, transfer center (TC) type warehouses have been increasing where received articles are shipped immediately (for example, during the arrival day). In a TC type warehouse, articles may sometimes arrive before arrival of shipping information. Even if the articles and the quantities thereof are known beforehand, the order of arrival of trucks changes depending on the traffic conditions. For this reason, unlike a DC type warehouse, a TC type warehouse cannot determine a compartment layout based on the ABC analysis that requires both of the shipping conditions and the inventory to be treated statically.

In a TC type warehouse, articles are usually distributed by allocating method. In the allocating method, a worker moves around with a cart containing one or a few kinds of articles and distributes required numbers of pieces of articles to the carts placed correspondingly to destination shops. The articles received at the TC type warehouse are total-picked in the previous warehouse and shipped from there; accordingly, it is easy to understand that, when all pieces in a cart have been distributed, the processing on the article is completed. However, when the number of destination shops is small, the allocating method urges the worker to pass by many shop carts and walk a long distance needlessly, and therefore, order picking method of distribution is suitable. In the order picking method, taking the same case as an example, the worker carries around a shop cart to successively pick up required numbers of pieces from the carts containing required articles.

As understood from the above, which is more efficient between the allocating method and the order picking method is determined depending on the relation between the number of kinds of received articles and the number of shops to deliver the articles and the amount of the articles. To determine which method is to be chosen, the number of kinds of received articles and the number of shops to deliver the articles are required.

In the TC type warehouse, however, even if information on the incoming articles is provided in advance, the order of arrival of the articles at the warehouse is not fixed. Although it is common to specify the estimated time of arrival, it happens frequently that the order of actual arrival is different from the specified one because trucks are affected by natural phenomena such as traffic jam.

If the work is started after all articles have arrived, an efficient method of shipping work can be used appropriately by choosing allocating method or order picking method based on the already received information on the incoming articles and the destination shops, and transferring and placing the carts containing the received articles to predetermined locations. If the work can be started when a certain extent of the articles have arrived, this method has an advantage that improves overall throughput. However, even if the locations for the carts are predetermined, the worker does not know when the article for a given location will arrive because the order of arrival of articles changes as described above, and therefore, the work cannot be started freely. This makes control of work assignment to the workers difficult, lowering the overall productivity and increasing the cost for work operation.

A conventional theory for a TC type warehouse is to distribute articles to shops by allocating method because the TC type warehouse receives total-picked articles. For example, if a warehouse is designed to have a space for placing as many carts as the destination shops for the allocating, empty carts can be prepared beforehand and allocating work can be started each time an article arrives. This method is advantageous to understand the operation but is less efficient for articles for which order picking method is more efficient. Furthermore, as the destination shops increase, cases for which order picking method is more suitable increase as well; accordingly, there is a problem that the overall efficiency will fall.

Therefore, a warehouse management system in an embodiment of this invention provides a temporary storage area (temporary storage system) between the receiving area and the shipping area to temporarily store received articles before sorting the articles by shipping destination and performs primary sorting of the carts there. Specifically, the warehouse management system loads the received articles to carts and arrays the carts two-dimensionally in the temporary storage area. For example, the system places a plurality of carts containing articles to be shipped to close numbers of destinations in a line and disposes such lines in rows in order of the number of destinations. The numbers of destinations are grouped into several categories predetermined from the number of available sorting work areas. That is to say, each line does not correspond to a single number of destinations but a predetermined range of number of destinations. For example, the system may place articles having 1 to 10 destinations to some line and place articles having 11 to 20 destinations to the next line.

Furthermore, the system places a lighter cart having a lower weight to the back of the line (closer to the unloading dock) and places a heavier cart to the front of the line (closer to the loading dock). The instruction on this is made by the location instruction system of this invention, based on the article attribute information such as the quantity, the weight, and the fragility of the article. For example, the system calculates the amount of energy (for example, the calories) required to move the article for a unit distance (for example, one meter) and depending on the amount of energy, places a cart that requires less energy at a location having a longer process distance to the loading dock and places a cart that requires more energy at a location having a shorter process distance to the loading dock.

For example, the required calories are estimated from the weight w [kg] of the worker, the weight m [kg] of the article, the lifting height h [m], and the travel distance d [m].

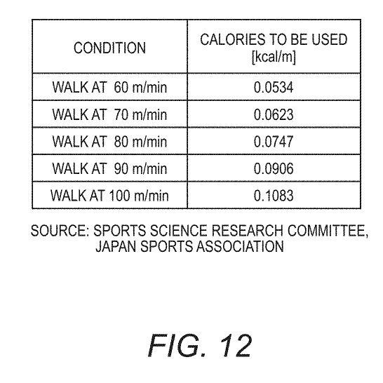

FIG. 12 is an explanatory diagram of calorie calculation to be performed by the warehouse management system in this embodiment.

Specifically, the table in FIG. 12 shows relations between the calories per unit weight to be used by walking for one minute and the walking speed. For example, the calories used when a worker having a weight w [kg] lifts up an article having a weight in m [kg] to a height h [m] and walks a distance d [m] at a speed 60 [m/min] is calculated by the following formula (1):

0.0534 [kcal/(kg·min)]·(w+m)[kg]×d[m]/60[m/min]+0.0023 [kcal/(kg·m)]·m[kg]·h[m]×2 (1)

The lifting height h [m] for the article may be determined by the height of the worker. The system calculates the calories to be used using not only the weight of the article but also the physical attribute information such as the weight and the height of the worker to perform the work. If the worker to perform the work cannot be determined, average physical attribute information may be used.

In this embodiment, articles are transferred to the sorting work area at a given time to start shipping (when the amount of articles have increased enough to operate the sorting work area, when the temporary storage area has got full, or when all articles have been received) line by line. The maximum number of lines of carts in the temporary storage area is preset by the user so as not to exceed the number of work lines of sorting work area. The warehouse in this embodiment can include a plurality of sorting work areas where sorting work can be performed independently from each other. In that case, each sorting work area may be referred to as a work line of sorting work area. In this embodiment, the method of sorting to be employed in each work line may be determined each time to start sorting work in the work line or predetermined specifically to the work line. In either case, sorting work can be performed concurrently in a plurality of work lines and the methods of sorting may be different among the work lines.

In starting sorting work, some carts may be moved from a line to an adjacent line to equalize the amounts of articles, the man-hours, or the working energy; as a result, the variation in work among the lines can be reduced to complete the work nearly the same time.

The carts are transported automatically (or manually in accordance with an instruction from the system) to a work line where order picking is to be performed if the category of the number of destinations of the line is of numbers higher than a specific number (which is determined by the user or automatically in accordance with the total number of destination shops) and to a work line where allocating is to be performed if the category of the number of destinations of the line is of numbers lower than the specific number, to achieve the best work productivity. That is to say, at any time determined freely by the user to start the sorting work, the distribution method optimum for the received articles as of the moment is chosen. Further, since the carts are lined up in order of required energy, assignment of workers in the sorting work line is facilitated.

Comparing the energy required to complete the work with the energy available from the workers based on the foregoing energy calculation formula and considering the comparison result in choosing the order picking method or the allocating method bring the best work performance of the workers available on the day. That is to say, although the energy available from the workers is limited, the work productivity is maintained as far as the work is within the limit. However, the work productivity falls when the work exceeds the limit. Accordingly, to save the energy, heavy articles may be partially processed by order picking method. In that case, the temporary storage area may be set up near the shipping waiting area and the worker may pick up articles directly from the temporary storage area to the carts in the shipping waiting area without using a sorting work area to save the energy further.

To save the energy of the worker, the working speed may be controlled. Walking too fast increases the use of energy; the energy may be exhausted during the first half of work so that the productivity in the latter half falls significantly and the work operation management fails. To prevent such a failure, the system may delay the instruction to start work to keep the throughput low. Choosing the sorting work method that uses less energy with sacrifice of throughput may attain the same effects.

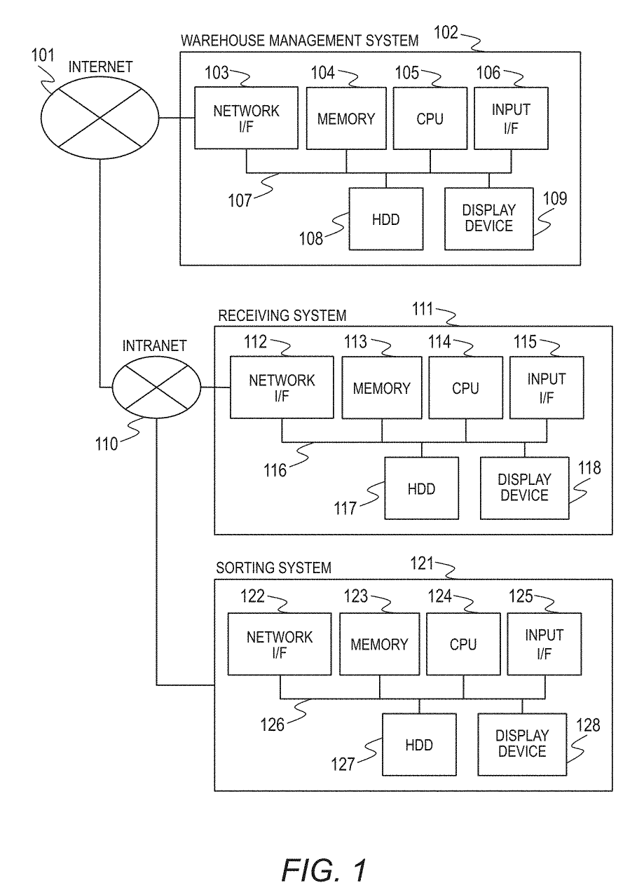

FIG. 1 is a block diagram for illustrating a hardware configuration of an overall warehouse system in this embodiment.

The warehouse system of this embodiment is generally composed of a warehouse management system 102, a receiving system 111, and a sorting system 121. The warehouse management system 102 is interconnected with the receiving system 111 and the sorting system 121 via an intranet 110. If secure connection via the Internet 101 is determined to be available in view of the recent advancement of the security technology, the connection via the intranet 110 is not essential. However, it is desirable that the warehouse management system 102 be connected with the Internet 101 because the system 102 needs to receive work orders from clients. It is obvious that the entire warehouse system in this embodiment can be closed within the intranet 110 in which each element is interconnected with another, by providing a firewall system or a server dedicated to receive work orders between the Internet 101 and the warehouse management system 102.

Each of the warehouse management system, the receiving system, and the sorting system includes a network interface, a memory, a central processing unit (CPU), an input interface, a hard disk drive (HDD) as a high-capacity storage device, and a display device as an information presentation means for a user.

The memory stores a program to be executed by the CPU, data to be referenced in processing performed by the CPU, and data created in processing performed by the CPU. Programs and data stored in the HDD may be copied to the memory as necessary and data updated on the memory may be copied from the memory to the HDD. In place of the HDD, a different type of high-capacity storage device such as a flash memory may be employed. When communication via the network is made in processing performed by the CPU, the communication is made through the network interface.

Specifically, the warehouse management system 102 includes a network interface 103, a memory 104, a CPU 105, an input interface 106, an HDD 108, and a display device 109, which are interconnected with one another by an internal bus 107.

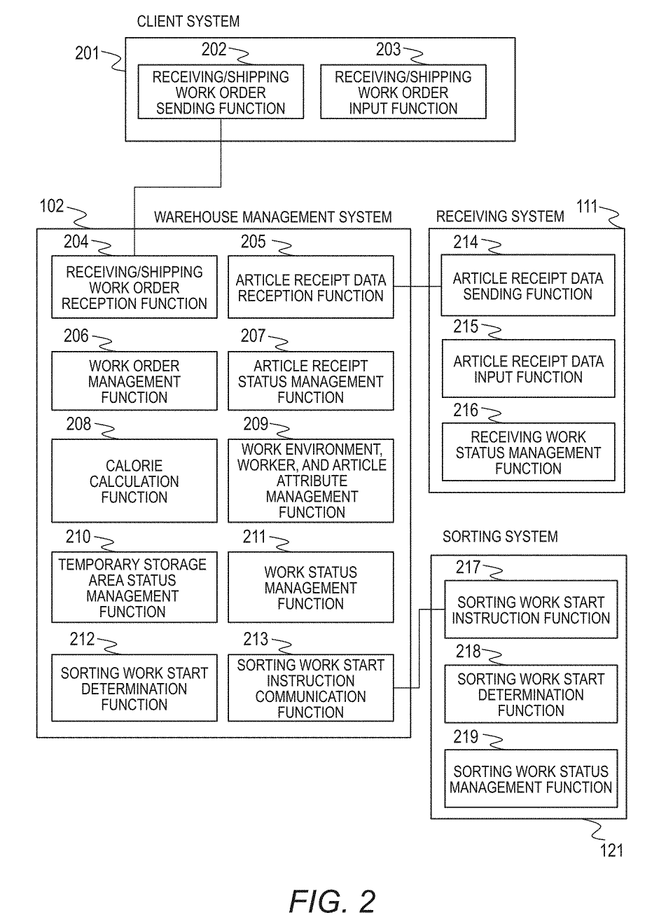

The CPU 105 executes a program stored in the memory 104 to implement functions of the warehouse management system 102. That is to say, the processing performed by the warehouse management system 102 in the following description, such as the processing performed by the functions shown in FIG. 2, is actually executed by the CPU 105 in accordance with a program stored in the memory 104.

The receiving system 111 includes a network interface 112, a memory 113, a CPU 114, an input interface 115, an HDD 117 as a high-capacity storage device, and a display device 118 as an information presentation means for a user. These components are interconnected with one another by an internal bus 116.

The CPU 114 executes a program stored in the memory 113 to implement functions of the receiving system 111. That is to say, the processing performed by the receiving system 111 in the following description, such as the processing performed by the functions shown in FIG. 2, is actually executed by the CPU 114 in accordance with a program stored in the memory 113.

The sorting system 121 includes a network interface 122, a memory 123, a CPU 124, an input interface 125, an HDD 127 as a high-capacity storage device, and a display device 128 as an information presentation means for a user. These components are interconnected with one another by an internal bus 126.

The CPU 124 executes a program stored in the memory 123 to implement functions of the sorting system 121. That is to say, the processing performed by the sorting system 121 in the following description, such as the processing performed by the functions shown in FIG. 2, is actually executed by the CPU 124 in accordance with a program stored in the memory 123.

FIG. 2 is a functional block diagram of the warehouse system in this embodiment.

The warehouse management system 102 has a receiving/shipping work order reception function 204 to receive a receiving/shipping work order from a client system 201. Although detailed description is omitted here, the client system 201 can be a computer system of a client connected with the Internet 101 and includes a receiving/shipping work order input function 203 to be used by the client to input a receiving/shipping work order and a receiving/shipping work order sending function 202 to send the input receiving/shipping work order.

The receiving work order is instruction information including information on the name of an article a client wants to bring in the warehouse, the quantity thereof, and a time. Upon receipt of this information, the warehouse prepares a storage area for the article to be received, arranges transport of the article to the storage area, and waits for actual arrival of the article. The shipping work order is instruction information including information on the name of an article a client wants to take out from the warehouse, the quantity thereof, a time, and a destination. Upon receipt of this information, the warehouse checks whether the article to be shipped is in stock, arranges a delivery truck, and arranges transport of the article from the storage area of the stock to the truck loading area. In this operation, if the article to be shipped is not in stock, the warehouse checks the next arrival of the article. If the next arrival is scheduled within the day, the article is shipped after receipt of the article, together with the articles taken out from the stock in the warehouse.

The foregoing work needs to be completed by the specified time and therefore, is performed unfailingly with sufficient productivity. For the purpose, the warehouse management system 102 has a work order management function 206. The work order management function 206 saves a received receiving/shipping work order (to the HDD 108, for example) and manages the progress of the work with a database. An article receipt status management function 207 manages receipt statuses, that is, which article included in a receiving/shipping work order has already been received and which article has not been received yet. A work status management function 211 manages progress of work based on information received from each system. Furthermore, the warehouse management system 102 has a work environment, worker, and article attribute management function 209 to manage which worker is doing which work and still having how much energy, and the conditions of articles (such as information on packaging, that is, whether the article is handled by carton or by piece). These are all used in calculating calories to be used in doing work.

The warehouse management system 102 has a calorie calculation function 208. Calculating calories here is to calculate calories to be used by a worker in doing some work and also to calculate calories recovering in the worker by lunch, for example. That is to say, the calorie calculation function 208 calculates the calories remaining in each worker as necessary for basic information in choosing a sorting work method or designing.

The warehouse management system 102 manages a temporary storage area for temporarily storing received articles before start of sorting work. Since the articles held in the temporary storage area change from hour to hour depending on the statuses of arrival of articles and the subsequent sorting work, the warehouse management system 102 has a temporary storage area status management function 210 to manage the status of articles in the temporary storage area.

Furthermore, the warehouse management system 102 has a sorting work start determination function 212 to determine whether to start sorting work. The sorting work start determination function 212 communicates information with the sorting system 121 through a sorting work start instruction communication function 213 when the function 212 determines that it is preferable to start the work in terms of the amount of articles held in the temporary storage area and reservation of required calories.

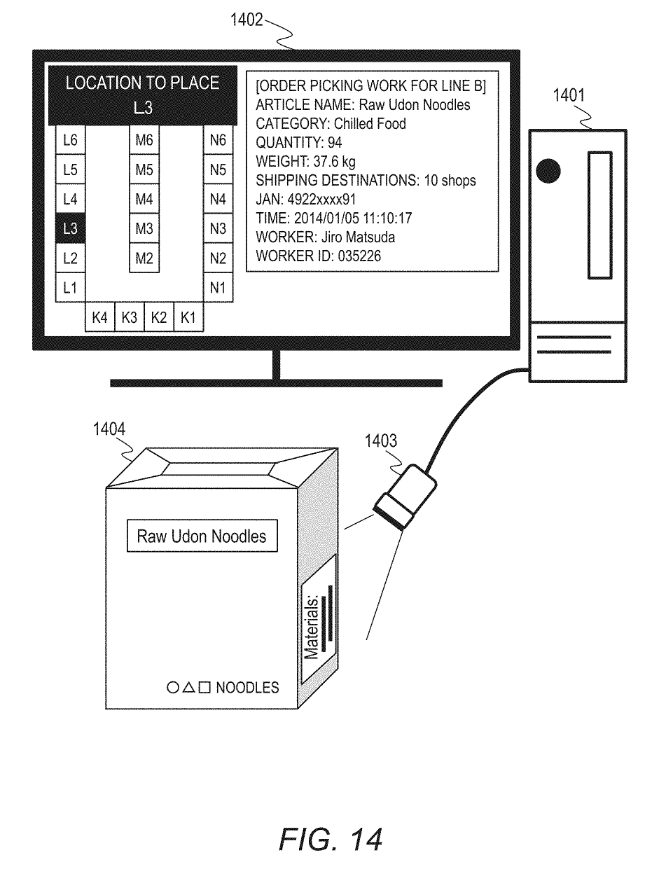

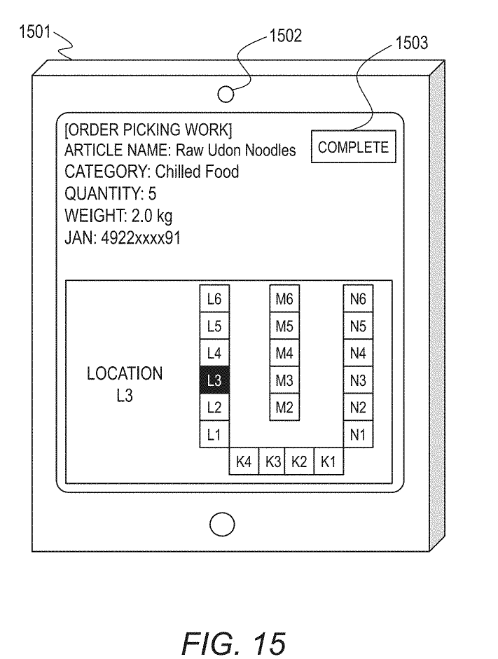

The sorting system 121 may have a sorting work start determination function 218 that determines whether to start sorting work independently (or without an instruction from the warehouse management system 102) and instructs the warehouse management system 102 to start sorting work. Alternatively, the sorting system 121 may have a sorting work start instruction function 217 that keeps waiting for an instruction to start sorting work from the warehouse management system 102 and upon receipt of the instruction, provides a guidance to start sorting work together with the method of the sorting work by screen, lamp, music, or speech to a terminal of a picker (see FIGS. 14 and 15, for example).

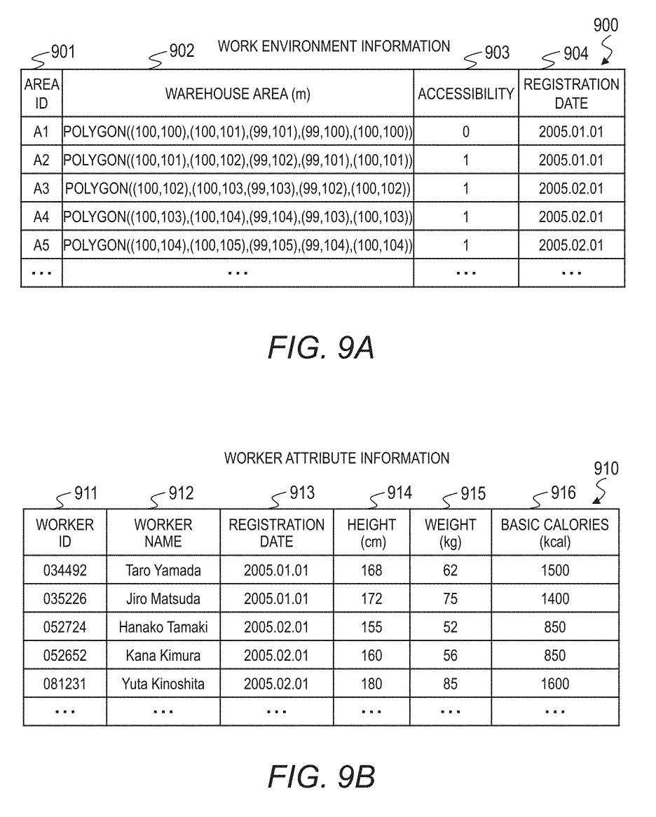

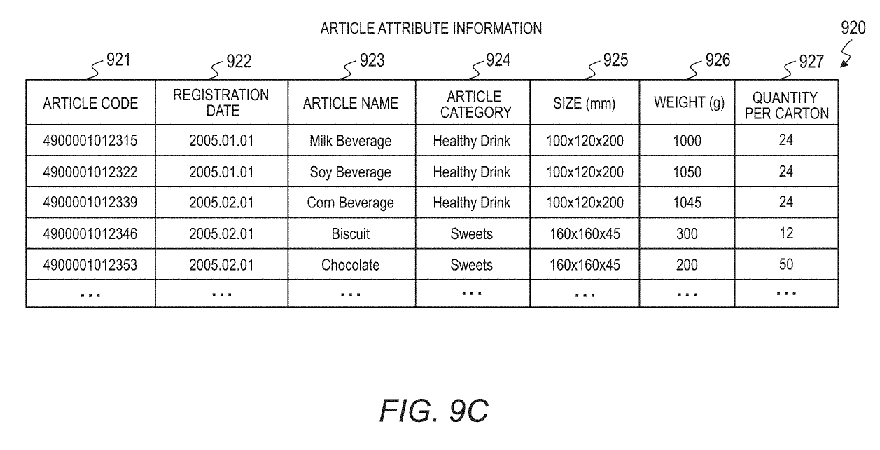

The receiving system 111 has an article receipt data input function 215 to input arrival or receipt of an article to the system. An example of the implementation thereof is input with a barcode reader. An incoming article is provided with a barcode printed thereon, the data about receipt of the article is input to the receiving system 111 by reading the barcode with a barcode reader (although not shown but connected with the input interface 115, for example) included in the receiving system 111. Since the barcode is obviously associated with an article in one-to-one correspondence, the receiving system 111 can further acquire the article attribute data corresponding to the barcode with reference to article master data (FIG. 9C) separately held by the receiving system 111 and input the acquired data together with the time of reading as article receipt data. The receiving system 111 sends the article receipt data to the warehouse management system 102 using an article receipt data sending function 214. This article receipt data is received by an article receipt data reception function 205 of the warehouse management system 102.

The receiving system 111 further has a receiving work status management function 216. The receiving work status management function 216 is a function to manage whether an article has actually been transferred based on information on the storage location sent from the warehouse management system 102 in response to article receipt data sent from the article receipt data sending function 214. For example, the article receiving worker notifies the receiving system 111 of completion of transfer by reading a barcode indicating the location where the article has been transferred. The receiving work status management function 216 determines that the work on the article has been completed based on this notification and notifies the work status management function 211 of the warehouse management system 102 of the completion of the work.

When the sorting work start determination function 218 of the sorting system 121 determines that sorting work can be started through an inquiry to a sorting work status management function 219, the sorting work start determination function 218 notifies the warehouse management system 102 that the sorting system 121 is available through the sorting work start instruction function 217. The sorting work status management function 219 manages the progress of sorting work at each time point and after completion of the sorting work, determines whether next sorting work can be started.

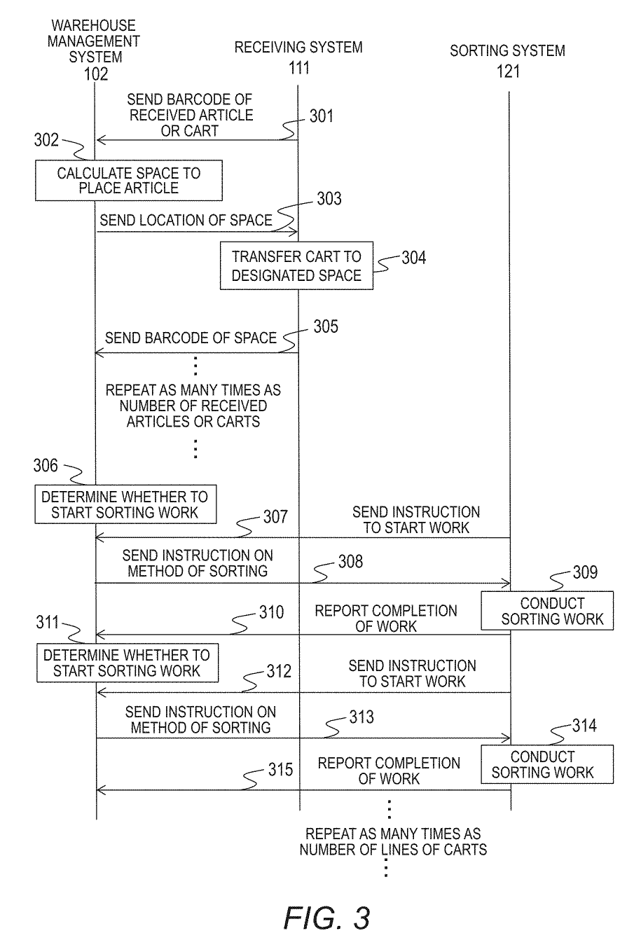

FIG. 3 is a sequence diagram for illustrating operation flow of the warehouse system in this embodiment.

Upon arrival of an article, the receiving system 111 reads the barcode of the article itself or the cart containing the article and sends it to the warehouse management system 102 (Step 301). The warehouse management system 102 calculates the space to temporarily store the article (for example, the coordinates of the space to place the article in the temporary storage area) based on the received information and information held by the system 102 (Step 302) and informs the receiving system 111 of the calculated space (Step 303).

The worker for the receiving system 111 transfers the article to the designated space (Step 304), reads the location information such as a barcode provided in the space, and sends the location information to the warehouse management system 102 (Step 305). The location information here is information indicating the location of one of the spaces in the temporary storage area and can be two-dimensional coordinates. This location information uniquely identifies a space. In each space (for example, on the floor, wall, or pillar in the space), a barcode including the location information of the space is provided. The worker retrieves this information with a barcode reader of the receiving system 111 and the receiving system 111 sends this information to the warehouse management system 102; thereby, the warehouse management system 102 is informed of completion of transfer of the article to the temporary storage area. The warehouse management system 102 checks that the received location information matches the information on the designated space, updates the temporary storage area information (to be described later) held by the warehouse management system 102, and terminates the processing.

In this embodiment, each article is put in a cart (which is a vehicle with a basket) and the worker carries the cart containing the article. This is merely an example of a means to collectively transport a plurality of articles (for example, a group consisting of a plurality of articles received from the same shipper, which can be a plurality of pieces of articles of a single kind or a plurality of pieces of articles of different kinds); the cart may be replaced by any other transport means (such as a vehicle without a basket, a carton, or a container). Further, in this embodiment, the information on the received article and the location information in the temporary storage area are provided in barcodes and retrieved with a barcode reader. However, this is merely an example of a method of forwarding information; any other means such as a wireless tag can be used.

The receiving system 111 and the warehouse management system 102 continue the same processing on all the received articles. Specifically, the receiving system 111 and the warehouse management system 102 perform Steps 301 to 305 on a cart containing received articles and repeat it until all the carts have been processed.

The warehouse management system 102 determines whether to start sorting work (Step 306). For example, the warehouse management system 102 may issue an instruction to start sorting work when the number of articles received and stored in the temporary storage area exceeds a certain level. This determination may use the number specified by the user in advance for the articles stored in the temporary storage area or the number of articles that can be disposed in the work areas owned by the sorting systems 121 that are available to start work as a threshold. Alternatively, the warehouse management system 102 may calculate the energy required for a worker to transfer the articles to each working area of the sorting systems 121 that are available to start work, and determine whether to start sorting work depending on the time estimated to complete the work in the sorting system 121 that requires least energy (for example, the sorting system 121 at the nearest location) and whether required energy will remain if this sorting work is started before all articles are received for the purpose of high productivity. This determination will be described later in detail.

Still alternatively, instead of the warehouse management system 102 at Step 306, the sorting system 121 may determine whether to start sorting work based on predetermined conditions. For example, the picker may determine when to start the next sorting work in accordance with the progress of current work, input the determination result to the sorting system 121, and the sorting system 121 may determine whether to start the sorting work in accordance with the input. In this case, the sorting system 121 sends an instruction to start work to the warehouse management system 102 (Step 307).

If determining to start sorting work at Step 306 or receiving the sorting work start instruction at Step 307, the warehouse management system 102 sends a sorting work instruction (Step 308). This sorting work instruction includes information on the method of sorting. The information on the method of sorting here is information of instruction whether to distribute the total-picked articles to the shipping destinations by allocating method or to take out from the total-picked articles for each shipping destination by order picking method. The sorting system 121 starts the sorting work in accordance with the designated method (Step 309). Upon completion of the sorting work, the sorting system 121 sends a completion notice of the work to the warehouse management system 102 (Step 310). The warehouse management system 102 determines that the work order has been processed upon receipt of the work completion notice.

If articles are left in the temporary storage area when the sorting work is completed (for example, in the case where articles newly arrive after start of the sorting work), the same processing as Steps 306 to 310 is repeated (Steps 311 to 315).

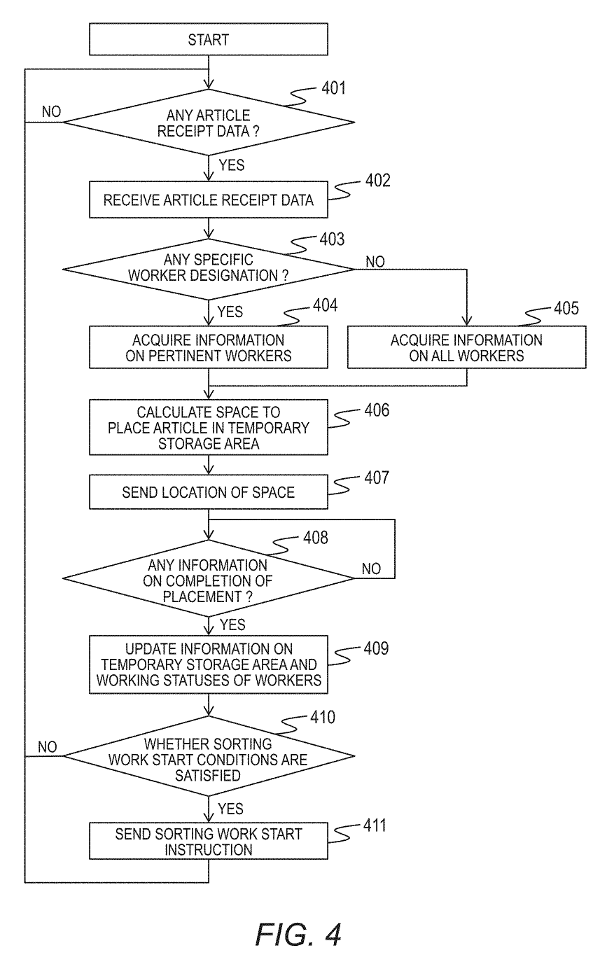

FIG. 4 is a flowchart of processing to be performed by the warehouse management system 102 in this embodiment in receiving work.

After starting, the warehouse management system 102 enters a standby mode for article receipt data (Step 401). This article receipt data corresponds to the barcode data sent at Step 301 in FIG. 3. In response to arrival of article receipt data, the warehouse management system 102 receives the article receipt data (Step 402) and checks whether specific worker designation exists (Step 403). The specific workers can be a list of workers who are available for the work on the day. A simple example thereof can be an attendance list of the day (or a list of workers attending on the day). The attendance list is managed by an attendance management system (not shown); this embodiment is based on an assumption that the warehouse management system 102 receives the attendance list from the attendance management system as the specific worker designation.

If such information is available (that is, if determining at Step 403 that specific worker designation exists), the warehouse management system 102 acquires information on the pertinent workers from master data (FIG. 9B) (Step 404). If such information is not available, the warehouse management system 102 acquires information on all workers from master data (Step 405). The information on physical attributes of the workers included in the acquired information is used to later-described calorie calculation.

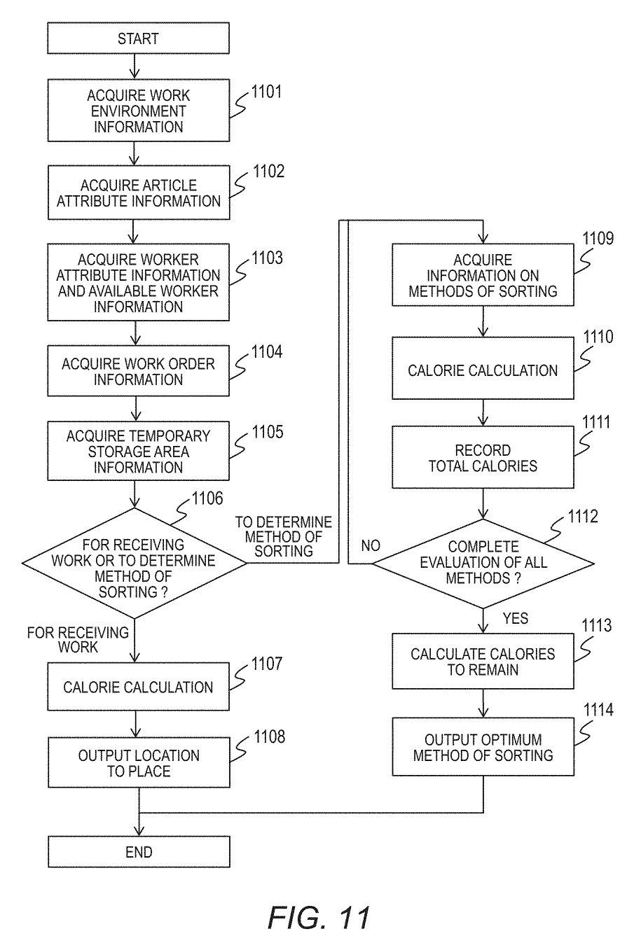

Next, the warehouse management system 102 calculates a space to place the received article in the temporary storage area (Step 406) and sends an instruction to the receiving system 111 to place the article to the obtained space (Step 407). These steps correspond to Steps 302 and 303 in FIG. 3. At Step 406, later-described calorie calculation may be performed (see FIG. 11, for example). The information on workers acquired at Step 404 or 405 is used in this calorie calculation.

Next, the warehouse management system 102 waits for information on completion of placement (Step 408). The information on completion of placement corresponds to the barcode information sent at Step 305 in FIG. 3, for example. Upon receipt of the information on completion of placement, the warehouse management system 102 updates information on the temporary storage area and information on working statuses of the workers (Step 409). Specifically, the later-described temporary storage area information 1020 is updated to indicate the latest layout of articles and in the later-described working status management data 1000, the calories used to place the article to the temporary storage area is subtracted from the calories remaining in the article receiving worker who has done this work.

Next, the warehouse management system 102 determines whether the sorting work start conditions are satisfied (Step 410). This determination corresponds to Step 306 in FIG. 3. An example of the determination on the sorting work start conditions is determining to start sorting work if a predetermined number of articles are placed in the temporary storage area. Usually, receiving work and sorting work are performed concurrently; the relation between the number of articles stored in the temporary storage area and the availability of work (the number of articles that can be additionally processed at each time point) in the sorting work area (the working area of the sorting system 121) varies with time. If the number of articles in the temporary storage area is simply employed as a criterion, a situation may happen where there is no work to do in the sorting work area; improvement in overall productivity is not expected. However, sending the next article from the temporary storage area each time one article has been processed in the sorting work area eliminates choice of an appropriate sorting work method; the chance to attain the optimum productivity will be missed.

In the case where the productivity of the warehouse system is represented by the throughput of articles in the warehouse system, it is desirable to start sorting work on a newly received article each time the article arrives in order to maximize the productivity of a transfer center type warehouse that does not allow accurate estimation of arrival times of articles. However, increase in number of times of execution of sorting work because of such operation causes increase in total energy used by the workers; the workers may get tired and diminish the productivity.

The warehouse management system 102 in this embodiment therefore determines whether to start sorting work based on the remaining energy (for example, remaining calories) available from the workers. That is to say, when sufficient energy is remaining compared to the energy required to complete the entire work, the warehouse management system 102 in this embodiment determines to start sorting work by issuing an instruction to send articles to the sorting work area even if the temporary storage area holds a small number of articles. Contrarily, if a little energy is remaining, the warehouse management system 102 determines not to start sorting work to keep the productivity for later work and accumulate more articles in the temporary storage area to recover the energy. Specific thresholds for these may be yielded from the history data on the working statuses managed by the warehouse management system 102, through correlation analysis of the use of calories and the productivity.

Now, an example of the determination at Step 410 is described. The warehouse management system 102 can identify all the items, quantities, and destinations of the articles to be shipped during the day based on work orders. Since the number of destinations of each article can be determined based on the work orders, the warehouse management system 102 can further determine the line to place each article in the temporary storage area before arrival of the article. Furthermore, the warehouse management system 102 can identify all articles already held in the temporary storage area and the destinations thereof based on the temporary storage area information 1020 and the cart information 1010.

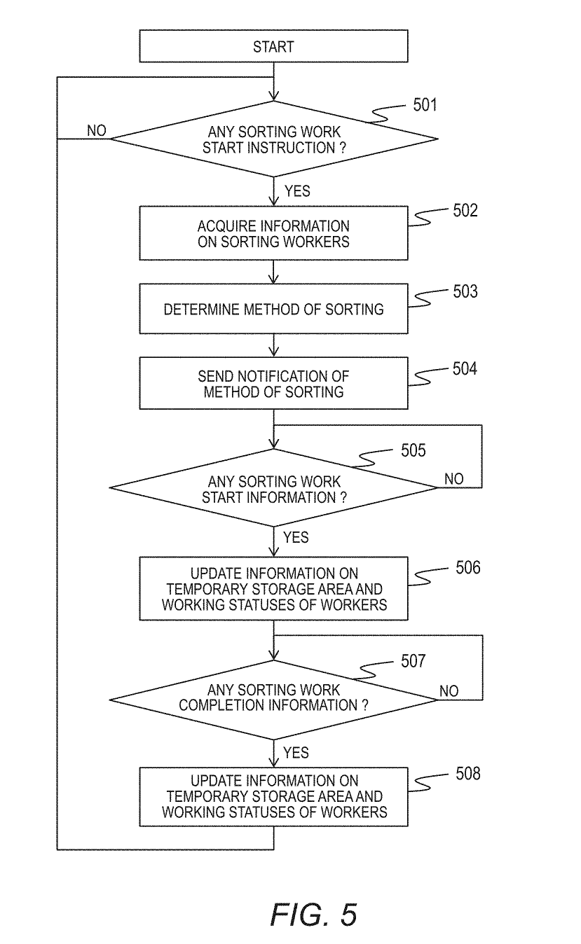

The warehouse management system 102 can calculate, on a line-by-line basis, the calories to be used in sorting work when the sorting work is performed on the articles currently held in the temporary storage area and when, assuming that the foregoing sorting work is completed, subsequent sorting work is performed on the remaining articles scheduled to arrive during the day after all the remaining articles are stored in the temporary storage area. If the worker to perform the sorting work cannot be determined, the calories may be calculated using the average weight of all workers, for example. The method of sorting is chosen by the later-described method (see FIG. 5).

The warehouse management system 102 determines to start sorting work (that is, sorting work start conditions are satisfied) on the articles in a line if the sum of the calories calculated about sorting the current articles in the line and the calories calculated about sorting the remaining articles based on an assumption that the sorting work on the line is completed is less than the total sum of the calories currently remaining in all workers; in the contrary case, the warehouse management system 102 determines not to start the sorting work. The warehouse management system 102 can make determination about the sorting work start conditions at Step 410 in this way, for example.

If determining at Step 410 that the sorting work start conditions are satisfied (or to start the sorting work), the warehouse management system 102 sends a sorting work start instruction to the sorting system 121 (Step 411) and then returns to the loop of waiting for the next article receipt data (Step 401). The instruction on the method of sorting at Step 308 in FIG. 3 may be included in the sorting work start instruction at Step 411. The functions to start sorting work will be described with reference to FIG. 5.

The warehouse management system 102 may calculate, on a line-by-line basis, the calories to be used in sorting work when the sorting work is performed on the articles currently held in the temporary storage area and when, assuming that the foregoing sorting work is completed, subsequent sorting work is performed on the remaining articles scheduled to arrive during the day after all the remaining articles are stored in the temporary storage area in both of the cases of the allocating method and the order picking method and determine whether to start the sorting work based on the method of sorting that uses less calories. The warehouse management system 102 that has determined to start sorting work may further output the method of sorting calculated to use less calories for the line determined to start sorting work. Such choice of the method of sorting can be made in accordance with the later-described procedure shown in Steps 1109 to 1114 in FIG. 11.

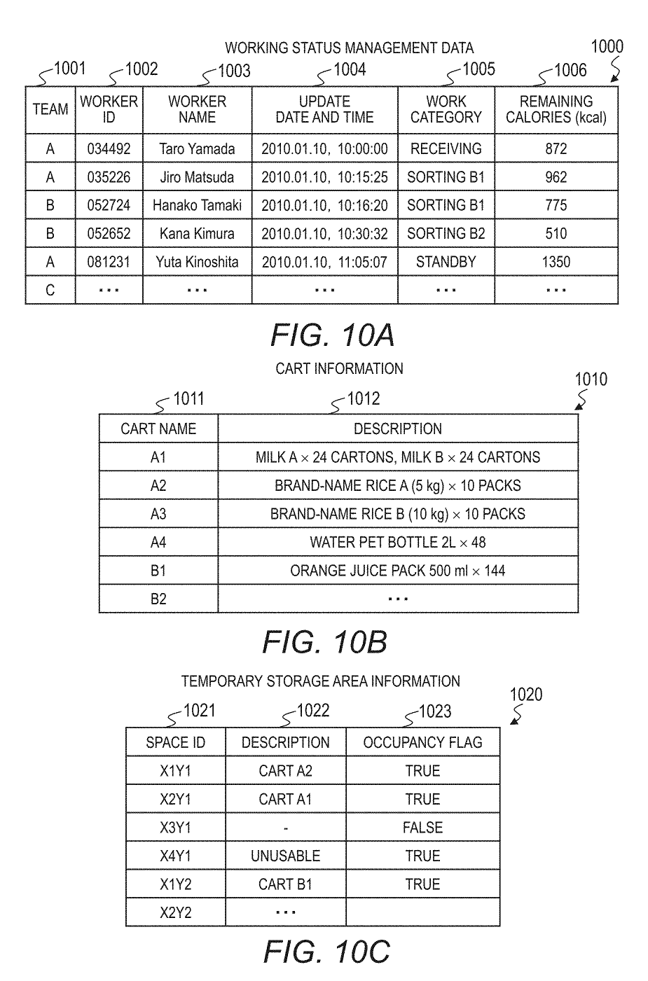

The warehouse management system 102 may determine an optimum cart layout in the sorting work area depending on the chosen method of sorting and output the result. The optimum cart layout can be determined using the same method as the one to be described later in the description of Step 1110 in FIG. 10. An example of outputting the determined cart layout will be described later with reference to FIG. 14.

The warehouse management system 102 may further calculate the calories to be used by each worker in the sorting work determined to start and determine whether the value obtained by subtracting the calculated calories from the calories remaining in each worker (or the calories remaining after completion of the sorting work) satisfies a predetermined condition. For example, the warehouse management system 102 may output the names of the workers whose calories to remain after the sorting work are less than a predetermined value. Taking measures such as not assigning the sorting work to such workers or giving some rest to such workers can prevent the productivity from dropping because of concentration of load to the specific workers.

FIG. 5 is a flowchart of processing to be performed by the warehouse management system 102 in this embodiment in starting sorting work.

After starting the processing in starting sorting work, the warehouse management system 102 enters the loop of waiting for a sorting work start instruction (Step 501). Upon receipt of a sorting work start instruction (for example, the sorting work start instruction at Step 411 in FIG. 4 or Step 307 in FIG. 3), the warehouse management system 102 acquires information on sorting workers (Step 502). The information on sorting workers may be created by the sorting system 121 based on the information input through the input interface 125 and sent to the warehouse management system 102 or may be a schedule of workers for each kind of work managed by the aforementioned attendance management system; the warehouse management system 102 may receive it from the attendance management system. The warehouse system generally holds information on the workers in either way for the purpose of history management or future quality control of sorting work.

Next, the warehouse management system 102 determines the method of sorting (Step 503) and notifies the sorting system of the method of sorting (Step 504). The warehouse management system 102 may determine the method of sorting based on the relation between the number of articles to be shipped and the number of destination shops. The warehouse management system 102 chooses the order picking method for the method of sorting if the number of articles to be shipped is larger than the number of destination shops and chooses the allocating method in the contrary case.

Alternatively, the warehouse management system 102 may calculate the amount of energy (specifically, calories) to be used in each method of sorting to determine the method of sorting. In that case, the warehouse management system 102 performs the later-described processing in FIG. 11 at Step 503.

A notification of the method of sorting includes the aforementioned information identifying the method of sorting and further, information specifying which article is to be placed to which space to perform the work. The specific space is determined based on the energy calculation (for example, calorie calculation). For example, it is preferable that where to place an article be determined depending on the distance from the temporary storage area to the sorting work area; specifically, a heavier article should be closer and a lighter article should be farther, and among the articles having the same weight, an article to be retrieved more frequently should be closer and an article to be retrieved less frequently should be farther, to use less calories in overall work.

In starting and ending sorting work, the sorting system 121 sends sorting work start information and sorting work completion information, respectively. Upon receipt of the sorting work start information (Step 505), the warehouse management system 102 updates information held in the warehouse management system 102 (specifically, the temporary storage area information and working status management data) in accordance with the sorting work start information (Step 506). Upon receipt of the sorting work completion information (Step 507), the warehouse management system 102 updates the same information in accordance with the sorting work completion information (Step 508). After completion of the foregoing processing, the warehouse management system 102 returns to the step of waiting for the next sorting work start instruction (Step 501).

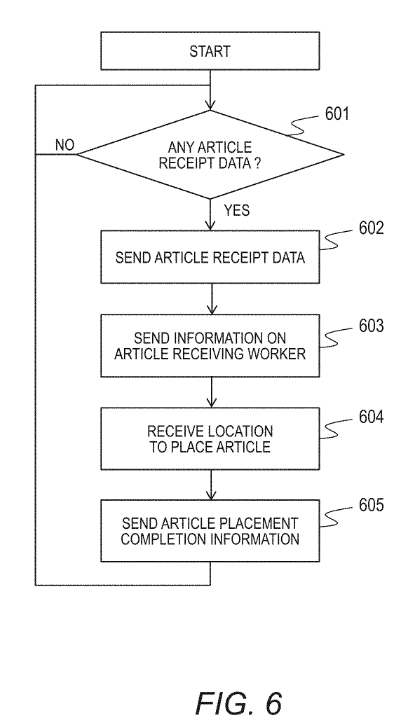

FIG. 6 is a flowchart of processing to be performed by the receiving system 111 in this embodiment.

After starting, the receiving system 111 enters the loop of waiting for article receipt data (Step 601). The article receipt data can be barcode information retrieved from a received article and acquired through a barcode reader (not shown) connected with the computer running the receiving system 111.

Upon acquisition of the article receipt data, the receiving system 111 sends the data to the warehouse management system 102 (Step 602). This step corresponds to Step 301 in FIG. 3. The receiving system 111 sends information on an article receiving worker together (Step 603).

The warehouse management system 102 determines where to place the article in the temporary storage area and sends information specifying the space to place the article to the receiving system 111. After receiving the information specifying the space to place the article at Step 604, the article receiving worker places the article based on this information. The receiving system 111 sends article placement completion information to the warehouse management system 102 (Step 605). The receiving system 111 repeats the foregoing processing each time the system 111 acquires article receipt data.

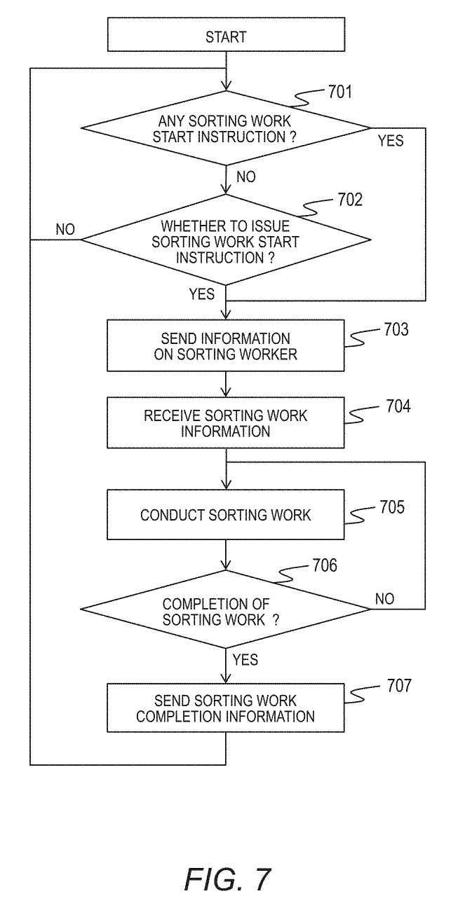

FIG. 7 is a flowchart of processing to be performed by the sorting system 121 in this embodiment.

After starting, the sorting system 121 checks whether a sorting work start instruction has been received (Step 701). This sorting work start instruction is sent from the warehouse management system 102 and upon receipt of the sorting work start instruction, the sorting system 121 starts sorting operation by sending information on a sorting worker (Step 703), regardless of whether the sorting work system 121 is conducting sorting work on another article or not.

If the sorting system 121 has not received a sorting work start instruction from the warehouse management system 102, the sorting system 121 determines whether the sorting system 121 is in condition to issue a sorting work start instruction (Step 702). If the sorting system 121 is in condition to issue a sorting work start instruction, the system 121 sends information on a sorting worker (Step 703). If the sorting system 121 is not in condition to issue a sorting work start instruction, the sorting system 121 returns to Step 701. Whether the sorting system 121 is in condition to issue a sorting work start instruction is determined depending on the status of work of the sorting system 121 as of the moment. Basically, when a sorting worker comes to a sorting work area where no sorting work is being conducted and makes the sorting system 121 recognize the worker's ID, the condition to issue a sorting work start instruction is satisfied. If sorting work on a different article is being conducted, the condition to issue a work start instruction is not satisfied.

Subsequent to Step 703, the sorting system 121 receives sorting work information (Step 704) and conducts sorting work (Step 705). Next, the sorting system 121 determines whether the sorting work has been completed (Step 706) and if not, continues the sorting work (Step 705). If the sorting work is completed, the sorting system 121 sends sorting work completion information (Step 707) and returns to Step 701. Step 707 corresponds to Step 310 in FIG. 3.

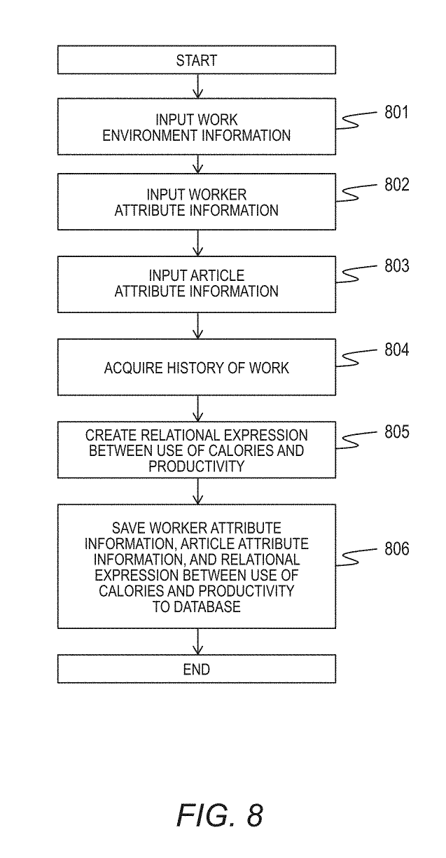

FIG. 8 is a flowchart of processing to be performed by the warehouse management system 102 in this embodiment to create master data.

The warehouse management system in this embodiment uses work environment information, worker attribute information, article attribute information, and data for a relational expression between use of calories and productivity. The warehouse management system 102 has a function to organize the foregoing data. After start of the warehouse management system 102, this function requests the user to input information on the work environment, attributes of workers, and attributes of articles. The user inputs requested information successively (Steps 801 to 803). Here, entering the information piece by piece on each item costs considerably because the same operation is required each time this system is deployed at a different site. Accordingly, at least part of the information may be input directly or indirectly from external databases to this system. For example, the worker attribute information may be downloaded from a file saved in csv format when the user designates the file name.

Next, the warehouse management system 102 acquires a history of work (Step 804). Next, the warehouse management system 102 calculates calories required to each kind of work using the history of work together with the data on the work environment, attributes of the workers, and attributes of the articles and compares the information on the productivity calculated from the history of work with the records of calories used in previous work to yield relational expressions between calories used by individual workers and the productivity (Step 805). If yielding relational expressions on individual workers is difficult, the warehouse management system 102 may create a relational expression on an average worker and thereafter yield relational expressions on individual workers.

After completion of entering and calculating the information described above, the warehouse management system 102 saves the information to a database (for example, a database (not shown) stored in the HDD 108) (Step 806) and completes creation of the master data.

FIGS. 9A, 9B, and 9C are explanatory diagrams of the work environment information, the worker attribute information, and the article attribute information, respectively, in the master data held by the warehouse management system 102 in this embodiment. These are examples of master data created in accordance with the procedure shown in FIG. 8.

Each record of the work environment information 900 includes an area ID 901, a warehouse area 902, accessibility 903, and a registration date 904. The area ID 901 is identification information of an area in the warehouse. The warehouse area 902 is information indicating the shape of the area and includes, for example, the coordinates of a point indicating the area or the coordinates of the apexes of the polygon defining the shape of the area. The accessibility 903 is an attribute value indicating whether the workers can enter the area (for example, 0: no access permitted, 1: access permitted). The accessibility 903 may be a binary attribute value for indicating a passage restriction as described above, however, it may include an attribute value for indicating a passage restriction selected from a various restrictions such as permitted to pass through in only one way, which should be only from the front, back, left, or right, and the like. The registration date 904 indicates the date of registration of the record.

The work environment information 900 defines the layout of the warehouse, namely, the location, shape, and restrictions on passage of each area and the locational relation among the areas. Accordingly, the warehouse management system 102 can search for a route to be taken by a worker to transfer a cart containing an article from an area to another, calculate the travel distance (or process distance) when the route is selected, and further, calculate calories to be used based on the travel distance.

Each record of the worker attribute information 910 includes information on attributes of a worker, specifically a worker ID 911, a worker name 912, a registration date 913, a height 914, a weight 915, and basic calories 916. The height 914 and the weight 915 of a worker are used to calculate calories to be used in work. Further, holding the basic calories 916 available per day enables more accurate estimation of productivity. If acquiring accurate information on these items is difficult, approximate values may be entered.

Each record of the article attribute information 920 includes information on attributes of an article, specifically, an article code 921, a registration date 922, an article name 923, an article category 924, a size 925, a weight 926, and a quantity per carton 927. The size 925 and the weight 926 of an article are used by the warehouse management system 102 to calculate calories to be used by a worker in each kind of work. The work may be performed in units of carton (for example, the worker transports a carton filled with pieces of articles) or not (for example, the worker takes out a necessary number of pieces from a carton and transport them). To enable calorie calculation in either case, the number of pieces per carton (namely the quantity per carton 927) is held. Accordingly, a receiving work order should include information indicating whether the quantity of the article is specified in the number of pieces or the number of cartons containing a predetermined number of pieces, in addition to the article code or article name to be handled in the work.

FIG. 10A is an explanatory diagram of working status management data managed by the warehouse management system 102 in this embodiment. This is stored in the HDD 108 of the warehouse management system 102, for example.

Each record of the working status management data 1000 includes information on the working status of a worker, specifically, a team 1001, a worker ID 1002, a worker name 1003, an update date and time 1004, a work category 1005, and remaining calories 1006. The warehouse management system 102 can overview the resources available in the warehouse with this data.

Specifically, the worker ID 1002 and the worker name 1003 are identification information of a worker. The team 1001 is identification information of the team the worker belongs to. For example, a series of sorting work in one sorting work area is performed by a plurality of sorting workers belonging to one team. The update date and time 1004 is a date and time of update of the record. The work category 1005 indicates the category of the work being performed by the worker when the information in the record is updated.

The remaining calories 1006 are the calories remaining in the worker when the information in the record is updated, or the calories the worker can use subsequent to the time point. A smaller value in the remaining calories 1006 indicates that the worker is more tired; the worker with a value zero in the remaining calories 1006 cannot be assigned further work unless the worker recovers by taking a meal or rest.

FIG. 10B is an explanatory diagram of cart information managed by the warehouse management system 102 in this embodiment. This is stored in the HDD 108 of the warehouse management system 102, for example.

Each record of the cart information 1010 includes information on the articles contained in a cart, specifically, a cart name 1011 and a description 1012. The cart name 1011 is identification information of a cart and the description 1012 includes information for identifying the items and the quantities of the articles contained in the cart. The description 1012 may include an article code (the code corresponding to the article code 921 in the article attribute information 920) of an article.

FIG. 10C is an explanatory diagram of temporary storage area information managed by the warehouse management system 102 in this embodiment. This is stored in the HDD 108 of the warehouse management system 102, for example.

The temporary storage area includes a plurality of spaces each of which is a space to place a cart. Each record of the temporary storage area information 1020 includes information indicating the status of use of the space in the temporary storage area, specifically, a space 1021, a description 1022, and an occupancy flag 1023.

The space ID 1021 is identification of a space. Since the carts are arrayed two-dimensionally in lines and rows in the temporary storage area as described above, the space ID 1021 may include two-dimensional coordinates indicating the location of the space in the temporary storage area as identification information of the space.

The description 1022 includes information describing the space. The information describing the space is, if the space is occupied by a cart, the identification information of the cart; if the space is not occupied by a cart, information indicating the fact (or vacancy); if a cart cannot be placed in the space (because of breakage of the floor, for example), information indicating “unusable”.

The occupancy flag 1023 indicates whether the space is occupied. For example, the occupancy flags 1023 of the spaces occupied by a cart and the spaces that cannot be used show a value indicating “occupied” and the occupancy flags 1023 of the other spaces show a value indicating “unoccupied”. The unoccupied spaces allow new placement of a cart.

The temporary storage area information 1020 is updated in accordance with a change of the condition of the temporary storage area caused by progress of article receiving work or sorting work.

FIG. 11 is a flowchart of processing to be performed by the warehouse management system 102 in this embodiment to calculate calories.

The calorie calculation function 208 first acquires the work environment information 900, the article attribute information 920, the worker attribute information 910, available worker information, work order information, and the temporary storage area information 1020 (Steps 1101 to 1105) to perform the subsequent processing.

The available worker information is a list of workers who can be assigned the work to be performed subsequently and can be a list of workers designated in specific worker designation, if any at Step 403 in FIG. 4. The work order information is information on receiving work orders and shipping work orders received by the receiving/shipping work order reception function 204. Every day, the warehouse management system 102 grasps the overall shipping work on the day, which means all shipping destinations and the items and the quantities of the articles for each destination, based on the information.

The calorie calculation function 208 implements two kinds of processing. One is calorie calculation in receiving processing and the other is calorie calculation in determining the method of sorting. The calorie calculation function 208 determines which processing is to be performed (Step 1106). Specifically, if the calorie calculation function 208 is started at Step 406 in FIG. 4, the calorie calculation function 208 determines to perform calorie calculation in receiving processing and if the calorie calculation function 208 is started at Step 503 in FIG. 5, determines to perform calorie calculation in determining the method of sorting.

The calorie calculation in receiving processing is performed to determine where to place an article (for example, a cart containing articles) in the temporary storage area. As already described, articles are disposed in lines in the temporary storage area and the line for each article is determined in accordance with the number of the shipping destinations of the article. The calorie calculation function 208 determines whether to place the article in the front (proximal side) or the back (distal side) of the determined line. The front and the back of a line means the end of the line close to and the end of the line far from the place where the article (such as a newly received article) to be transferred to the temporary storage area is currently placed, specifically a place near an unloading dock.

For example, the calorie calculation function 208 calculates calories to be used by a worker to carry a newly received article to the temporary storage area (Step 1107), compares the calculated calories with the calories used to carry an article already placed in the temporary storage area, determines to insert the newly received article in the front of the line if the calories calculated at Step 1107 are higher and to place the newly received article in the back of the line if the calories calculated at Step 1107 are lower, and outputs the result (Step 1108). In the case where a plurality of articles (for example, a plurality of carts) are already placed in the line to include the newly received article, the calorie calculation function 208 may compare the average of the calories about the articles with the calories calculated at Step 1107.

The use of calories tends to be more as the carried article is heavier; accordingly, the above-described method will determine to place a heavy article in the front of a line and a light article in the back, thereby preventing the process distance of the heavy article from getting long. However, in order to add an article to a line in which many articles are already placed, the calories to be used to push the articles toward the back of the line are required; accordingly, the method may determine to place the heavy article in the back of a line. Such determination can save the calories to be used in the overall work.

Inserting an article in the front of a line requires pushing the articles already placed in the line by one space. When many carts are already placed in a line, considerable calories are used, even if the articles are stored in a mobile rack with casters like a cart. Accordingly, when the calories remaining in the worker are not enough to insert the article in the front of the line, the calorie calculation function 208 instructs the worker to place the article to the back of the line.

If determining at Step 1106 that the calorie calculation is to determine the method of sorting, the calorie calculation function 208 first acquires information on the available methods of sorting (Step 1109). The methods of sorting available in this embodiment are allocating method and order picking method. Next, the calorie calculation function 208 calculates the total calories required to perform the work in each method (Step 1110) and records the results (Step 1111).

For example, in the case where sorting work on one of the lines in the temporary storage area is determined to be started at Step 410 in FIG. 4, the calorie calculation function 208 calculates the total calories to be used to sort the articles in the line in each case of employing allocating method and order picking method. The articles contained in the carts belonging to the line are identified based on the cart information 1010, the information such as the weights of the articles is determined based on the article attribute information 920, and the shipping destinations and the quantities of the articles to be shipped are identified based on the work order information. Further, if the available worker information (for example, information at Step 404 in FIG. 4) is acquired at Step 1103, the weights of the workers are determined based on this information and the worker attribute information 910. If the available worker information is not acquired, the calorie calculation function 208 may use the average of the weights of all workers or a predetermined standard value. The calorie calculation function 208 calculates the total calories to be used in each method of sorting using such information.

To calculate a process distance in the sorting work, the calorie calculation function 208 needs to acquire the layout information on the warehouse and in addition, to determine the cart layout as shown in FIG. 21. The calorie calculation function 208 may determine the cart layout in accordance with predetermined policies. For example, in calculating the calories to be used in the order picking method, the calorie calculation function 208 identifies the shipping destinations of the articles contained in each cart and determines the layout of the article carts so that the cart containing articles to be shipped to more destinations will be placed near the shop cart. In calculating the calories to be used in the allocating method, the calorie calculation function 208 identifies the carts containing articles to be shipped for each destination and determines the layout of the shop carts so that the shop cart for the destination of articles contained in more article carts will be placed near the article carts. This arrangement achieves a shorter total process distance in the sorting work area along which a worker carries a cart from the beginning to the end of the sorting work.

After completing calculating and recording the total calories in all methods of sorting (Step 1112), the calorie calculation function 208 compares the total calories to be used in each method of sorting with the total calories remaining in the workers, compares the necessary calories estimated from the amount of the remaining work orders with the total calories remaining in the workers (Step 1113), determines the optimum method of sorting based on the comparison results, and outputs the result (Step 1114). That is to say, if the remaining calories are enough to process the remaining work orders, the calorie calculation function 208 selects the method of sorting that can be completed soonest and in the other case, selects the method of sorting that uses less calories. The time required to complete the work can be obtained by simulation of sorting work in each method of sorting. Alternatively, the calorie calculation function 208 may select the method of sorting that uses less calories, regardless of the total remaining calories.

At Steps 1107 and 1110, the calories can be calculated based on the conditions shown in FIG. 12, for example, but may be calculated by a different method.

Although this embodiment describes a configuration to determine the layout of articles in the temporary storage area and select the method of sorting based on the calories that are comparatively easy to calculate, this invention can be implemented based on energy, instead of calories. A method of evaluating the used energy and the remaining energy by calculating the amount of work more precisely from the weights of articles, the weights of workers, and the travel distances can attain the same effects as the method using the used calories. It can be said that the used calories in this embodiment is used energy calculated by an easy method, which is not highly accurate but accurate enough to attain the effects of this invention. Likewise, this invention can employ a method of calculating a value corresponding to the used energy with a certain level of accuracy, if any.

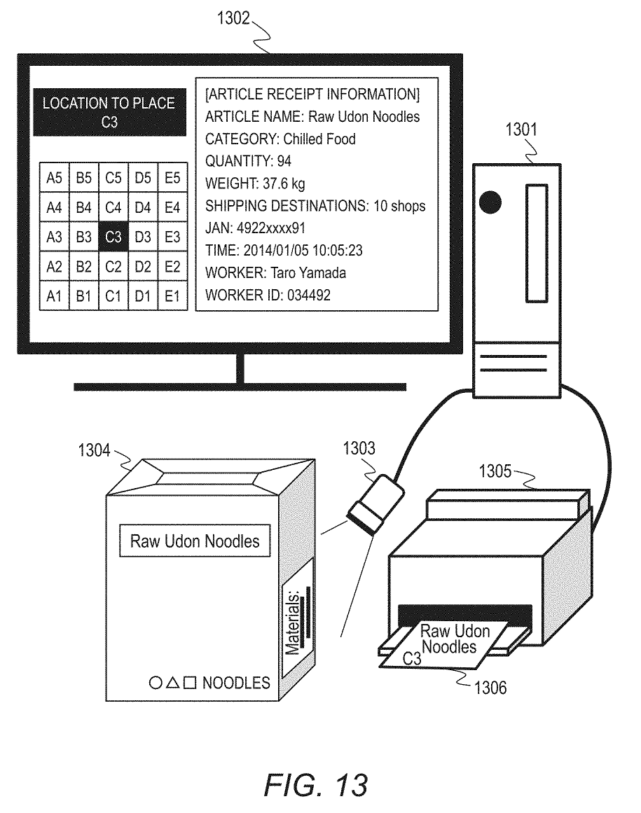

FIG. 13 is an explanatory diagram of an example of a screen displayed by the receiving system 111 in this embodiment.

The computer 1301 running the receiving system 111 is equipped with a barcode reader 1303 in addition to a keyboard and a mouse as the input interface 115. The worker reads a barcode on an article with the barcode reader to send the retrieved information to the warehouse management system 102. The warehouse management system 102 acquires more detailed information such as the article name, the size, and the weight from the article master data (specifically, the article attribute information 920) based on the received information and further, the quantity of the article from the article receipt data. The warehouse management system 102 performs calorie calculation based on the acquired information and instructs the receiving system 111 where to store the article in the temporary storage area based on the result.

The display device 1302 (corresponding to the display device 118 in FIG. 1) of the receiving system 111 displays the instruction from the warehouse management system 102. The screen displays the ID (for example, “C3”) of a space in the temporary storage area to place the article and further, a plan view indicating the location of the space on the left of the screen. The worker can place the article to the correct location in the temporary storage area with reference to these indications.

Further, the screen displays detailed information on the received article such as the article name and the category of the article on the right of the screen to prompt the worker to be sure that the worker is actually working on the article. Furthermore, the computer 1301 running the receiving system 111 is connected with a printer 1305, which prints a label to be attached to the cart containing the article. On this label, the information equivalent to the information displayed on the display device, that is, information on where to place the article and the attribute information such as the article name are printed. Such a label attached to the cart enables the worker not to forget where to place the article even if the worker leaves the computer. This label may further include a barcode including at least information for identifying the cart.

After placing the article to the specified space, the worker uses a handy barcode reader to read a barcode provided in the space. This handy barcode reader may be the same one as the barcode reader 1303 connected with the computer 1301 of the receiving system 111 or a different one. Although FIG. 13 shows a barcode reader 1303 connected to the computer by a cable, a handy barcode reader capable of wireless connection can replace it as such handy barcode readers are widely used these days.

The receiving system 111 or the warehouse management system 102 may be configured to determine that placement of a cart is completed only in the case where a handy barcode reader successively reads the barcode on the label attached to the cart and the barcode including the location information of the space and the time difference in the reading is less than a predetermined value. This configuration can reliably associate the cart with the space using a handy barcode reader.

Furthermore, the receiving system 111 or the warehouse management system 102 may detect return of the handy barcode reader and determine completion of the work when the worker reads a barcode on the body or in the vicinity of the computer 1301 with the handy barcode reader. This configuration prevents loss of equipment (or the handy barcode reader).

FIG. 14 is an explanatory diagram of an example of a screen displayed by the sorting system 121 in this embodiment during the work of placing articles.

As described above, the warehouse management system 102 sends instruction information on where to place articles as well as the method of sorting to the sorting system 121. The sorting system 21 that has received this information displays specific location information on the display device 1402 (corresponding to the display device 128 in FIG. 1) of the computer 1401. Although the articles to be processed in the sorting work area has been brought from the temporary storage area on a line-by-line basis (Line B in the example of FIG. 14), where to place each article is not known; accordingly, when the barcode on an article 1404 is read with a barcode reader 1403 of the sorting system, the display device 1402 displays identification information on the space to place the article in the sorting work area and a plan view indicating the location of the space with detailed information on the article. Further, although not shown in FIG. 14, the sorting system 121 may also be connected with a printer. A label indicating the space to place the article may be printed and attached to the cart so as to eliminate the worker from getting puzzled about where to place the cart.

FIG. 15 is an explanatory diagram of an example of a screen displayed on a tablet terminal to be used by a worker in sorting work in this embodiment.

The tablet terminal 1501 in FIG. 15 is an example of a terminal device to be carried by a sorting worker in doing sorting work. The tablet terminal 1501 includes a camera 1502; the work is configured to progress by reading a barcode with the camera 1502. FIG. 15 shows a screen displayed in the order picking method of sorting by way of example; the worker starts moving with an empty shop cart to collect articles. The tablet terminal 1501 displays information on the article to be picked next, the quantity thereof, and the location. The worker takes out the article from the cart disposed in the sorting work area and takes a picture of the barcode on the article with the camera 1502 of the tablet terminal 1501. Upon completion of the work, the worker presses a COMPLETE button 1503 and proceeds to the next article.

In the allocating method of sorting, the procedure is almost the same. The worker first places empty shop carts to the designated spaces in the sorting work area in accordance with an instruction from the system and then distributes each article in the required number of pieces for the shops in accordance with an instruction shown on the tablet terminal 1501.

As described above, the warehouse system in this embodiment operates the processing from receiving to sorting optimally based on the energy calculation to increase the productivity.

Hereinafter, specific examples of the above-described embodiment are described where the warehouse system of this invention is applied to two types of warehouses, a transfer center type warehouse and a storage type warehouse.

### EXAMPLE 1

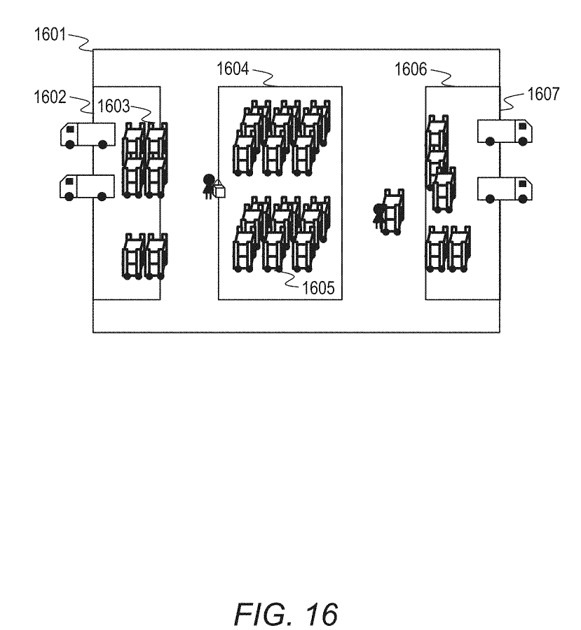

FIG. 16 is an explanatory diagram for illustrating a configuration of a transfer center type warehouse in Example 1 of this invention.

The transfer center type warehouse ships all received articles in a short period. Accordingly, the warehouse does not have extra stock; the main work there is to recombine or process the articles in transferring the articles.

The warehouse 1601 has an unloading dock 1602 and a loading dock 1607; articles arrive at the unloading dock. The articles to be received at a transfer center type warehouse are picked in batches of required quantities and loaded to carts or palettes. In other words, the warehouse receives articles total-picked in an external warehouse or factory.

For example, in the case of receiving articles in carts 1603, each cart 1603 basically contains a large number of articles of one kind. Although a plurality of kinds of articles can be contained together, the following description is provided assuming a case of a single kind because the same method for the case of a single kind of articles is applicable.

The articles in the carts 1603 are successively distributed to shop carts 1605 (initially, they are empty) for the destinations in the sorting work area 1604. This is a method called allocating method. Since each received cart 1603 carries necessary and sufficient number of articles, sorting work on a cart is completed when the articles have been allocated. However, each shop cart 1605 needs to contain a plurality of kinds of articles, the shop cart 1605 cannot be completed unless allocating other articles is completed.

In contrast, the method of disposing carts containing the received articles in the working area and the worker walks around with a shop cart to take out necessary articles is called order picking method. If all the articles to be shipped are disposed in the working area, shipping to a shop is ready when a worker has completed the work on one shop cart; accordingly, the order picking method is easy to control the work, compared to the allocating method.

Through a sorting work area 1604 to perform the above-described work, the shop carts are lined up by destination in the shipping arrangement area 1606, loaded to shipping trucks, and shipped from the loading dock 1607.

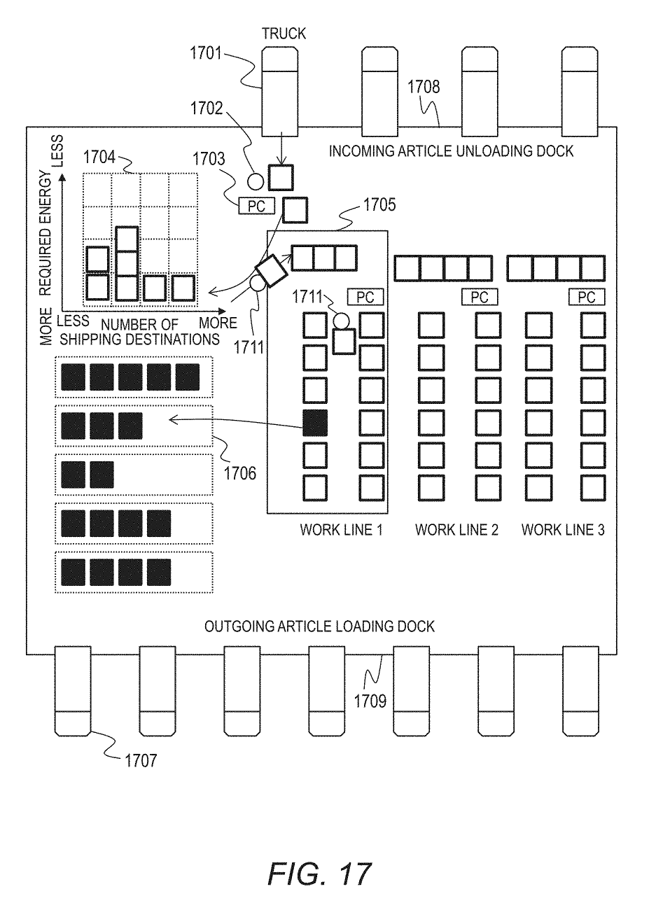

FIG. 17 is an explanatory diagram for illustrating the work performed in a transfer center type warehouse in Example 1 in more detail.

The articles successively arrive at the incoming article unloading dock 1708 in the upper part of the drawing. Carts are represented by squares in FIG. 17. Arrival times of the trucks 1701 for transporting articles are roughly scheduled; however, the actual arrival times can be different from the schedule depending on the time taken to load the articles and/or traffic conditions and as a result, the order of arrival can be different from the scheduled one. Accordingly, it is difficult to determine the order of processing the articles in advance.

Each time a truck 1701 arrives, an article receiving worker 1702 unloads articles from the truck 1701. With this operation, the receiving system 1703 (corresponding to the receiving system 111 in FIG. 1) notifies the warehouse management system 102 of arrival of the articles. In response to this notification, the warehouse management system 102 sends an instruction where to place each article in the temporary storage area 1704. In the example of FIG. 17, each block divided by dotted lines corresponds to a space for placement; each series of spaces extending in the vertical direction in the drawing is referred to as line and each series of spaces extending in the horizontal direction is referred to as row. Each article is placed at a space specified by the line determined in accordance with the number of destinations and the row determined in accordance with the required amount of energy.

The reason why to determine the line to place an article in accordance with the number of destinations of the article is that the method of sorting is related to the number of destinations. If the number of destinations is large, a large number of shop carts are used in the sorting work area. Accordingly, compared to the order picking method where a worker walks around with the shop carts one by one, the allocating method basically requires less calories and therefore, the allocating method is more likely to be selected. Contrarily, if the number of destinations is small, the order picking method where a worker walks around with the small number of shopping carts requires less calories and therefore, the order picking method is more likely to be selected. Even if the system suffers from a blackout and is temporarily stopped, the work can be continued without dropping the efficiency by choosing the allocating method or the order picking method for each line in the temporary storage area.

As already explained, increase in number of times of execution of sorting work causes increase in total calories to be used. However, to reduce the number of times of execution of sorting work, many articles should be processed in a series of sorting work, which causes increase in calories used in the series of sorting work. Accordingly, whether reduction in the number of times of execution of sorting work actually reduces the total calories to be used depends on the relationship between these two factors. The extents of increase in calories to be used because of increase in article to be processed in a series of sorting work are more likely to be different depending on the selected method for the sorting work.

When the allocating method is selected, the worker has to repeatedly walk around with a cart containing received articles. If the worker starts the work after waiting for arrival of more articles, more carts have to be carried around in a series of sorting work and as a result, the calories used in the series of sorting work will increase. On the other hand, when the order picking method is selected, the number of carts to be carried around by a worker in a series of sorting work sometimes does not much correspond to the number of received articles, although it depends on the relationship between the received articles and the destinations. This indicates that, compared to the case where the order picking method is selected, the total calories used in the allocating method is unlikely to decrease even if the frequency of execution of sorting work is reduced, that is, it is more likely to be determined to start sorting work before many articles are accumulated.

As described above, since the allocating method is likely to be selected for a line of articles having many destinations, it can be said that sorting work is likely to be executed more frequently for a line of articles having more destinations. Accordingly, providing such a line of articles having more destinations at a location closer to the sorting work area leads to saving the total process distance between the temporary storage area and the sorting work area and further, reducing the increase in total calories to be used.

Where to place articles in each line is determined as described with reference to FIGS. 4 and 11. Note that the “front of a line” in the description of FIG. 11 corresponds to the side close to the incoming article unloading dock 1708 in the line, namely the upper side of the drawing in the example of FIG. 17 and the “back of the line” corresponds to the opposite side.

The articles placed in the temporary storage area 1704 are sent to a sorting work line 1705 by a sorting worker 1711 (or article receiving worker) line by line at a predetermined time (see Step 410 in FIG. 4). The warehouse in this example has a plurality of sorting work lines 1705. Each sorting work line 1705 corresponds to the sorting work area in the foregoing description. The PC 1710 provided for each sorting line 1705 corresponds to the sorting system 121. Allocation of a sorting work line 1705 for articles is determined by the warehouse management system 102, based on the calories to be used. Each sorting work line 1705 is applicable to both of the allocating method and the order picking method by selecting the positional relation between the article carts arid the shop carts (see FIG. 21). The carts on which sorting work by the sorting worker 1711 has been completed are stocked to a shipping arrangement area 1706 one after another.

The articles ready to be shipped among the articles stocked in the shipping arrangement area 1706 are loaded to trucks 1707 that arrive at outgoing article loading dock 1709 and shipped.

### EXAMPLE 2

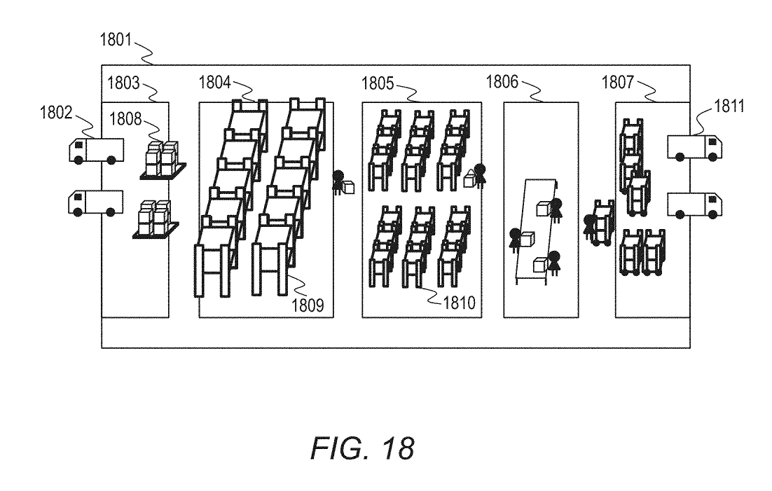

FIG. 18 is an explanatory diagram of a first configuration example of a storage type warehouse in Example 2 of this invention.

Unlike a transfer center type warehouse, a storage type warehouse 1801 has stock. A shipping instruction is basically for shipping an article from a stock. The transfer center type warehouse is suitable to ship articles stored for a short period and the storage type warehouse is suitable to ship articles stored for a long period. The storage type warehouse has effect of absorbing variation in the amount of an article, if the amount of production of the article varies with day or season. In the example of FIG. 18, articles stacked on palettes 1808 are unloaded from the trucks 1802 on the left of the drawing in an article receiving area 1803 and stored to storage racks 1809 in a palette storage area 1804 in the state where the articles are on the palettes. Thereafter, the articles are separately transferred as necessary from the palette storage area 1804 to replenish case/piece storage racks 1810 in a case/piece storage area 1805 where articles are stored by case or piece. Each time of receipt of a shipping order, order picking is performed from the case/piece storage racks 1810. The order-picked articles are packed for shipment in an inspection/packing work area 1806, loaded to a cart, and shipped by a truck 1811 from a shipping area 1807.

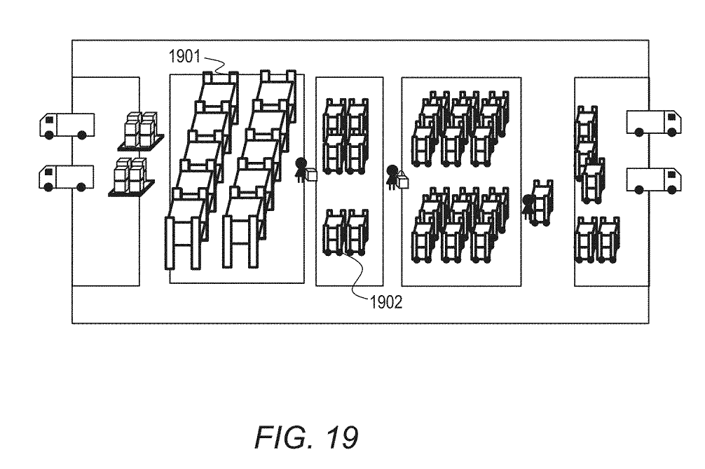

FIG. 19 is an explanatory diagram of a second configuration example of a storage type warehouse in Example 2 of this invention.

In the storage type warehouse shown in FIG. 19, total picking is performed. The total picking corresponds to the work performed by the supplier of an article received by a transfer center type warehouse before shipping the article. The total quantity of articles to be shipped on the day are collectively retrieved from the storage area 1901, loaded to a cart 1902, and forwarded to the next step. Accordingly, the configuration subsequent to the total picking in the storage type warehouse in FIG. 19 is the same as the configuration in the transfer center type warehouse shown in FIG. 16. That is to say, the carts 1902 in FIG. 19 are treated in the same way as the carts 1603 in FIG. 16.

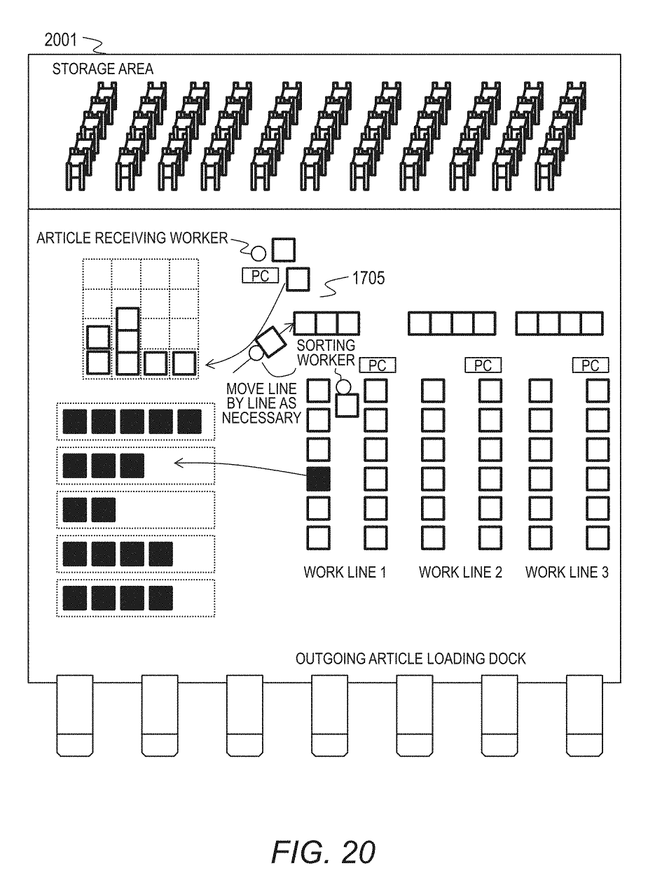

FIG. 20 is an explanatory diagram for illustrating the work performed in a storage type warehouse in Example 2 in more detail.

The example of FIG. 20 corresponds to the storage type warehouse shown in FIG. 19. The part of the incoming article unloading dock from trucks in FIG. 17 is replaced by a storage area 2001 in FIG. 20; as total picking in the storage area 2001 progresses, articles are successively received by the part of this system. The times of completion of total picking in the example of FIG. 20 vary depending on the congestion and progress of the workers, like the variation in arrival time among trucks depending on the traffic conditions and the progress of work in the example of FIG. 17. Accordingly, the restrictions and situations described above apply this example. Since the processing performed after total picking in the storage type warehouse in this example is the same as the processing in Example 1, the explanation thereof is omitted here (see FIG. 17, for example).

As understood from the above, the warehouse management system of this invention is applicable to both of the transfer center type warehouse and the storage type warehouse.

One of the features of the warehouse system in the present embodiment is a temporary storage area where the articles are arrayed two-dimensionally. The temporary storage area is divided into grids of sub-areas, each of which is assigned an area number (for example, “C3” in FIG. 13). The warehouse management system 102 instructs the receiving system 111 on the area number. The worker who has received the instruction from the receiving system 111 (for example, the worker who has seen the indication on the display device 1302) transfers a cart containing received articles to the specified area. For the worker to easily check that the cart is delivered to the specified area through this work, the temporary storage area may have guide rails on the floor. Forming a bump with a guide rail so as to jolt the cart passing thereon enables the worker to estimate the current position with the jolt without frequently looking down at (or looking up) the signs provided on the floor (or hung from the ceiling) to check the area.

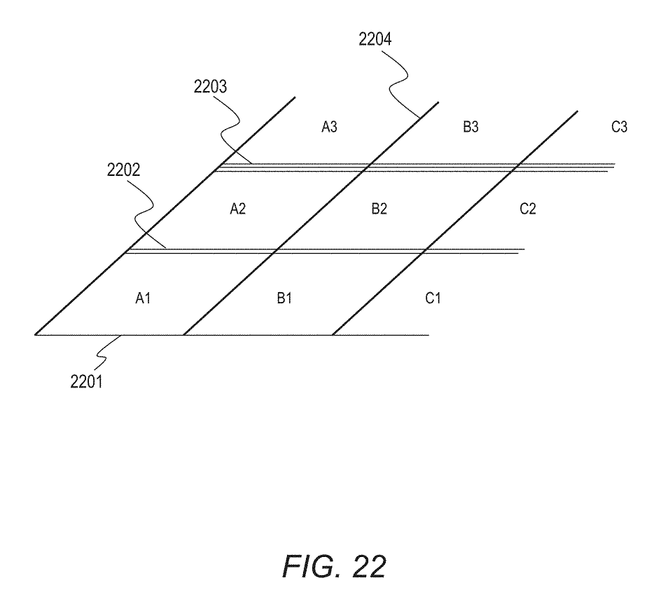

FIG. 22 is an explanatory diagram of a configuration example of the temporary storage area in this embodiment.

The temporary storage area is divided into a plurality of sub areas (blocks) by thin wires 2201, 2202, and 2203 stretched on the floor in the lateral direction (or the row direction) and thick wires 2204 stretched in the longitudinal direction (or the line direction). For example, the areas A1, A2, and A3 shown in FIG. 22 constitute a line and each of the areas corresponds to a space to place a cart. For example, the area A1 can be the front of the line and the area A3 can be the back of the line. In similar, the areas B1, B2, and B3 constitute another line, and the areas C1, C2, and C3 constitute still another line.

When the worker pushes a cart to the temporary storage area from the front or the back of a line, the cart passes the thin wires 2201 to 2203, generating a slight bounce and jolt. The worker senses the bounce, jolt, or the sound caused thereby to know which sub area in the line the cart has entered depending on how many times the pattern is felt, one time, two times, or three times.

Meanwhile, thick wires (for example, thicker than the wires 2201 to 2203) are stretched in the lateral direction. Since these wires form bumps higher than the bumps formed by the thin wires, a cart is prevented from accidentally entering the next line; accordingly, it is easy to move the cart only in the longitudinal direction (line direction).

This example stretches wires on the floor of the temporary storage area; however, this is an example of a way of providing bumps on the floor (specifically, low bumps by thin wires and high bumps by thick wires). A desired number of bumps having desired heights can be provided by a different way.

The above-described embodiment can increase shipping productivity by choosing an appropriate method of sorting based on the attributes of the workers and the data on the articles to be shipped. Particularly, in the sorting work area to which articles to be shipped are successively coming, choosing allocating method or order picking method as the method of sorting depending on the number of shipping destinations of the articles and the remaining energy available for the work leads to the best productivity under the given working conditions.

Furthermore, calculating the calories to be used by workers facilitates the calculation of energy to be used. Using the layout information on the warehouse and the physical attribute information on the workers can raise the accuracy in energy calculation. Providing a temporary storage area for storing the received articles before starting sorting work and determining the line and the location in the line to place each article in the temporary storage area based on the energy to be used and the number of shipping destinations of the article lead to saving the energy of the workers and increasing the productivity. Determining whether to start sorting work based on the energy remaining in the workers and if determining to start, outputting the optimum method of sorting and the optimum layout of the articles in the sorting work area for each line in the temporary storage area lead to saving the energy of the workers and increasing the productivity. Outputting workers whose remaining energy satisfy a predetermined condition prevents concentration of work to a specific worker and increases the productivity. Providing specific bumps to the boundaries of sub-areas to place articles in the temporary storage area assists the workers in checking the location to place an article in the temporary storage area and increases the productivity.

It should be noted that this invention is not limited to the above-described embodiments but include various modifications. For example, the above-described embodiments have provided details for the sake of better understanding of this invention; they are not limited to those including all the configurations that have been described. A part of the configuration of each embodiment may be replaced with a configuration of another embodiment or a configuration of an embodiment may be incorporated to a configuration of another embodiment. A part of the configuration of each embodiment may be added, deleted, or replaced by that of a different configuration.

The above-described configurations, functions, and processing units, for all or a part of them, may be implemented by hardware: for example, by designing an integrated circuit. The above-described configurations and functions may be implemented by software, which means that a processor interprets and executes programs providing the functions. The information of programs, tables, and files to implement the functions may be stored in a storage device such as a memory, a hard disk drive, or an SSD) (Solid State Drive), or a storage medium such as an IC card, or an SD card.

The drawings shows control lines and information lines as considered necessary for explanations but do not show all control lines or information lines in the products. It can be considered that most of all components are actually interconnected.

What is claimed is:

1. A warehouse management system comprising:
a processor; and
a storage device coupled to the processor,
wherein the storage device holds work order information including shipping destinations of articles received at a warehouse and quantities of articles to be shipped to each of the shipping destinations, article attribute information including weights of articles, and layout information on the warehouse, and
wherein the processor is configured to:
calculate energy to be used by a worker to be involved in sorting work in sorting articles received at the warehouse by shipping destination in cases of using a plurality of methods of sorting, based on the work order information, the article attribute information, and the layout information; and
output a method of sorting that is calculated to use the least energy.

2. The warehouse management system according to claim 1, wherein the plurality of methods of sorting includes allocating method of sorting and order picking method of sorting.

3. The warehouse management system according to claim 1, wherein the processor is configured to calculate calories to be used by a worker as the energy to be used by the worker.

4. The warehouse management system according to claim 1,
wherein the storage device further holds worker attribute information about physical attributes of a plurality of workers, and
wherein the processor is configured to calculate the energy to be used by a worker based on the work order information, the article attribute information, the layout information, and the worker attribute information on workers who are available to perform the sorting work.

5. The warehouse management system according to claim 1,
wherein the warehouse includes a temporary storage area to temporarily store the received articles before start of sorting work,
wherein the temporary storage area includes a plurality of blocks, and
wherein the processor is configured to:
calculate energy to be used by a worker in placing the received articles to the plurality of blocks, based on the work order information, the article attribute information, and the layout information;
determine blocks to place the received articles based on a result of comparison of the energy calculated for the received articles with energy calculated for articles already placed in the temporary storage area; and
output a determined result.

6. The warehouse management system according to claim 5,
wherein the temporary storage area is divided into a plurality of lines each including a plurality of blocks,
wherein the received articles are carried by a worker in article groups each including a plurality of articles, and
wherein the processor is configured to:
determine, for each of the article groups, a line to place the article group based on the numbers of shipping destinations of the articles in the article group; and
determine, for each of the article groups, a block to place the article group based on a result of comparison of energy calculated for the article group with energy calculated for article groups already placed in the determined line.

7. The warehouse management system according to claim 6, wherein the processor is configured to determine a line to place the article group in such a manner that an article group having more shipping destinations is placed in a line closer to a sorting work area where the sorting work is to be performed.

8. The warehouse management system according to claim 6,
wherein the storage device further holds information on energy remaining in workers and available for later use,
wherein the work order information includes information on quantities and shipping destinations of all articles scheduled to be subjected to sorting work on the day, and
wherein the processor is configured to:
determine whether to start sorting work on article groups placed in one of the lines based on a result of comparison of a sum of calculated energy to be used by a worker in sorting the article groups placed in the one of the lines and calculated energy to be used by workers in sorting all remaining article groups scheduled to be subjected to sorting work on the day with the remaining energy; and
output a result of the determination.

9. The warehouse management system according to claim 8, wherein the processor is configured to:
compare a sum of the calculated least energy to be used by a worker in sorting the article groups placed in the one of the lines using any one of the plurality of methods of sorting and the calculated least energy to be used by workers in sorting all remaining article groups scheduled to be subjected to sorting work on the day using any one of the plurality of methods of sorting with the remaining energy; and
output a method of sorting with which the calculated energy to be used for the article group is the least, in a case of determining to start sorting work on the article groups placed in the one of the lines.

10. The warehouse management system according to claim 9,
wherein the plurality of methods of sorting are allocating method of sorting and order picking method of sorting,
wherein each article group is held by a cart, and
wherein the processor is configured to:
determine a layout of carts to hold articles to be shipped to shipping destinations in the sorting work area where the sorting work is to be performed based on the number of article groups including articles to be shipped to the shipping destinations in a case of determining to start sorting work on the article groups placed in the one of the lines and further determining the calculated energy to be used in sorting the article groups using the allocating method of sorting is lower;
determine a layout of carts holding the article groups in the sorting work area based on the number of shipping destinations of the articles included in the article groups in a case of determining to start sorting work on the article groups placed in the one of the lines and further determining the calculated energy to be used in sorting the article groups using the order picking method of sorting is lower; and
output the determined layout of carts.

11. The warehouse management system according to claim 8, wherein the processor is configured to output a list of workers who satisfy a predetermined condition on difference between the calculated energy to be used for the article groups and the remaining energy, in a case of determining to start sorting work on the article groups placed in the one of the lines.

12. The warehouse management system according to claim 6, wherein the processor is configured to calculate energy to be used by a worker in performing the sorting work on all article groups placed in one of the plurality of lines.

13. The warehouse management system according to claim 6,
wherein the layout information includes attribute information on an article receiving area to receive the articles, the temporary storage area, a sorting work area to perform the sorting work, and areas connecting the areas, and
wherein the processor is configured to:
search for a traveling route from an area to another area based on the layout information; and
calculate the energy to be used based on a distance of the detected traveling route.

14. A warehouse to be managed by the warehouse management system according to claim 6,
wherein each article group is held by a cart,
wherein a floor of the warehouse is provided with different numbers of bumps having a first height along boundaries between the plurality of blocks included in each line, and
wherein the floor is provided with bumps having a second height higher than the first height along boundaries between the plurality of lines.

15. A warehouse management method to be performed by a computer including a processor and a storage device coupled to the processor,
the storage device holding work order information including shipping destinations of articles received at a warehouse and quantities of the articles to be shipped to each of the shipping destinations, article attribute information including weights of articles, and layout information on the warehouse, and
the warehouse management method comprising:
calculating, by the processor, energy to be used by a worker to be involved in sorting work in sorting articles received at the warehouse in cases of using a plurality of methods of sorting, based on the work order information, the article attribute information, and the layout information; and
outputting, by the processor, a method of sorting that is calculated to use the least energy.
